(19) United States
(12) Patent Application Publication
(10) Pub. No.: US 2015/0341442 A1
(43) Pub. Date: Nov. 26, 2015

(54) COMMUNICATION MANAGEMENT SYSTEM

(71) Applicant: Takeru INOUE, Kanagawa (JP)

(72) Inventor: Takeru INOUE, Kanagawa (JP)

(21) Appl. No.: 14/718,959

(22) Filed: May 21, 2015

(30) Foreign Application Priority Data
May 21, 2014 (JP) 2014-104815

(51) Int. Cl. H04L 29/08; G06F 17/30

(52) U.S. Cl. CPC H04L 67/141; G06F 17/30345

(57) ABSTRACT

Described herein is a server for managing a communication system including a plurality of terminals. The server includes circuitry configured to in response to an initiation request from an initiating terminal, generate a session ID and allocate a relay device, update the session management database based on the generated session ID and allocated relay device, transmit information identifying the generated session ID and the allocated relay device to the initiating terminal and destination terminals identified by the requesting terminal, establish a content data session between the requesting terminal and the one or more destination terminals, designate an owner terminal and one or more participating terminals for the content data session from the requesting terminal and the destination terminals based on information in a terminal management database, and instruct transmission of sound permission instructions to the owner terminal and sound restriction instructions to the one or more participating terminals.

### CROSS-REFERENCE TO RELATED APPLICATIONS

This patent application is based on and claims priority pursuant to 35 U.S.C. §119(a) to Japanese Patent Application No. 2014-104815, filed on May 21, 2014, in the Japan Patent Office, the entire disclosure of which is hereby incorporated by reference herein.

### BACKGROUND

1. Technical Field

The disclosures herein generally relate to a technique for controlling communication connections during terminal to transmit content data.

2. Description of the Related Art

A communication system is a technology to conduct videoconferences, perform calls, and so on via communication networks such as the Internet. Owing to the recent demand for reducing time and expenses for business trips, such communication systems are becoming increasingly popular. The communication system may be implemented by transmitting and receiving content data such as image data and sound data between two or more communication terminals at different locations.

The content data transmitted from the communication terminal is delivered to the other communication terminals in real time so that the communication system can be utilized for lecturing. In this case, when the content data is transmitted interactively via a network between the presenting communication terminal and a participating communication terminal, network traffic and noise is great. As a result, when utilizing the communication terminal for lecturing, a technique such as restricting transmission of the content data from the participating terminal is known.

### SUMMARY

Example embodiments of the present disclosure include a server for managing a communication system, the server includes a terminal management database storing terminal information identifying each terminal and indicating an ownership status for each terminal, a session management database storing information regarding a session and circuitry configured to in response to an initiation request from an initiating terminal, generate a session ID and allocate a relay device, update the session management database based on the generated session ID and allocated relay device, instruct transmission of information identifying the generated session ID and the allocated relay device to the initiating terminal and one or more destination terminals identified by the requesting terminal, establish a content data session between the requesting terminal and the one or more destination terminals, designate an owner terminal and participating terminals for the content data session from the requesting terminal and the one or more destination terminals based on information in the terminal management database, and instruct transmission of sound permission instructions to the owner terminal and sound restriction instructions to the participating terminals, the sound permission instructions unmuting the owner terminal and the sound restriction instructions muting the participating terminals.

Example embodiments of the present disclosure include that the initiation request from the initiating terminal includes information identifying a conference mode, and the conference mode is selected from one of a sound mute mode and a mutual communication mode.

Example embodiments of the present disclosure include that the circuitry designates the owner terminal and participating terminals for the content data session and instructs transmission of the sound permission instructions to the owner terminal and the sound restriction instructions to the participating terminals only when the initiation request includes the information identifying the conference mode as the sound mute mode.

Example embodiments of the present disclosure include that when the initiation request includes the information identifying the conference mode as the mutual communication mode, each of the requesting terminal and one or more destination terminals receive sound permission instructions instructing unmuting of the respective terminal.

Example embodiments of the present disclosure include that the circuitry is further configured to receive a confirmation or a rejection of the content data session from each of the one or more destination terminals, the one or more destination terminals initiating an obtaining of the confirmation or rejection of the content data session in response to the receipt of the information identifying the generated session ID and the allocated relay device.

Example embodiments of the present disclosure include that in response to the owner terminal exiting the content data session due to lack of connectivity, the circuitry is further configured to instruct transmission of a notification to the participating terminals indicating that the owner terminal has exited the content data session.

Example embodiments of the present disclosure include that when the owner terminal reconnects to the server after exiting the content data session due to lack of connectivity, the owner terminal is rejoined to the content data session and the circuitry is further configured to again instruct transmission of the sound permission instructions to the owner terminal.

Example embodiments of the present disclosure include that in response to the owner terminal exiting the content data session due to lack of connectivity, the circuitry is further configured to re-designate one of the participating terminals as a new owner terminal and instruct transmission of the sound permission instructions to the new owner terminal.

Example embodiments of the present disclosure include a method for managing a communication system including a server and a plurality of terminals. The method includes the steps of in response to an initiation request from an initiating terminal of the plurality of terminals, generating a session ID and allocate a relay device, updating a session management database storing information regarding a session based on the generated session ID and allocated relay device, instructing transmission of information identifying the generated session ID and the allocated relay device to the initiating terminal and one or more destination terminals identified by the requesting terminal, establishing a content data session between the requesting terminal and the one or more destination terminals, designating an owner terminal and participating terminals for the content data session from the requesting terminal and the one or more destination terminals based on information in a terminal management database storing terminal information identifying each terminal and indicating an ownership status for each terminal, and instructing transmission of sound permission instructions to the owner terminal and sound restriction instructions to the participating terminals, the sound permission instructions unmuting the owner terminal and the sound restriction instructions muting the participating terminals.

Example embodiments of the present disclosure include a terminal for initiating a content data session with one or more destination terminals. The terminal includes video capturing circuitry configured to capture still and dynamic pictures, audio capturing circuitry configured to capture audio, circuitry configured to receive information identifying a generated session ID and an allocated relay device, receive sound permission instructions when the terminal is designated by the server as an owner terminal and receive sound restriction instructions when the terminal is designated by a server as a participating terminal, the sound permission instructions unmuting the owner terminal and the sound restriction instructions muting the participating terminals, and transmit both audio and video respectively captured by the video capturing circuitry and the audio capturing circuitry when sound permission instructions are received and the terminal is designated as the owner terminal.

Example embodiments of the present disclosure include that the circuitry is further configured to instruct transmission of an initiation request for initiating the content data session with one or more destination terminals to the server.

Example embodiments of the present disclosure include that when the terminal is designed as the owner terminal, the circuitry is further configured to instruct display of an option screen permitting selection from the one or more destination terminals, and in response to receiving selection of one of the one or more destination terminals, instruct display of a second option screen permitting selection of one of a sound mute mode and a mutual communication mode for the content data session.

Example embodiments of the present disclosure include that when the terminal is designed as one of the participating terminals, the circuitry is further configured to instruct display of an option screen permitting confirmation or rejection of the content data session.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration diagram illustrating a communication system according to an embodiment;

FIG. 2 is an external view of a communication terminal according to the embodiment;

FIG. 3 is a hardware configuration diagram illustrating a transmission terminal in the transmission system according to the embodiment;

FIG. 4 is a hardware configuration diagram illustrating a transmission management system, a relay device, a program providing system, or a maintenance system in the transmission system according to the embodiment;

FIG. 5 is a functional block diagram of the management system, the terminal and the relay device;

FIGS. 6A-D are a conceptual diagram illustrating each table managed by the communication management system;
(A) is an illustration of a terminal authentication management table;
(B) is an illustration of a terminal management table;
(C) is an illustration of a candidate list management table;
(D) is an illustration of a session management table;

FIG. 7 is a conceptual diagram illustrating transmitting and receiving statuses of image data, sound data and various management information in the communication system;

FIGS. 8A-B are a sequence diagram illustrating a process of a preparatory phase when the communication terminals initiate the communication;

FIGS. 9A-B are a conceptual diagram illustrating an address list according to an embodiment;

FIGS. 10A-B are a sequence diagram illustrating a process of communication start at the terminal;

FIG. 11 is a conceptual diagram illustrating an address list according to an embodiment;

FIGS. 12A-B are a conceptual diagram illustrating an example of an output image;

FIG. 13 is a sequence diagram illustrating a process when the terminal exits the content data session;

FIG. 14 is a sequence diagram illustrating a process of a participation in the content data session;

FIG. 15 is a flowchart illustrating a process of an updating the status of the terminal;

FIGS. 16A-B are a conceptual diagram illustrating an address list according to an embodiment;

FIG. 17 is a conceptual diagram illustrating a terminal management table of the embodiment;

FIG. 18 is a sequence diagram illustrating a process when the terminal 10 exits the content data session; and

FIG. 19 is an illustrates an example of an address list of the embodiment;

The accompanying drawings are intended to depict example embodiments of the present invention and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, a first embodiment of the present invention will be described with reference to the drawings.

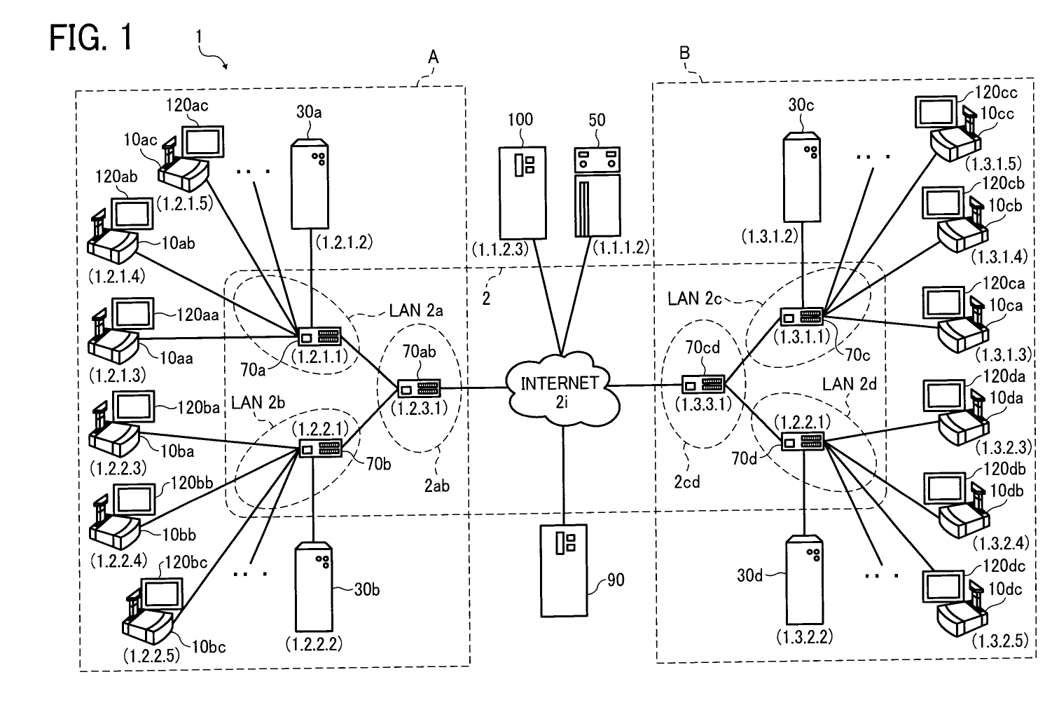

In the following, preferred embodiments will be described with reference to the figures. FIG. 1 is a schematic diagram illustrating a communication system 1 according to an embodiment. Initially, an outline of the communication system 1 according to the embodiment is described with reference to FIG. 1.

There are various types of communication systems. One example may be a data providing system. In the data providing system, content data are transmitted from one communication terminal to another communication terminal via a communication management system in a one-way direction. Another example may be a communication system. In the communication system, information or emotional expressions are mutually communicated among two or more communication terminals via the communication management system. The communication system is utilized for mutually exchanging information or emotional expressions among the two or more communication terminals (i.e., the communication terminals) via a communication management system (i.e., the communication management system). Examples of the communications system include a videoconference system, a videophone system, an audio conference system, an audio-call system, and a personal computer screen sharing system.

The following embodiments describe the communication system, the communication management system, and the communication terminal by conceptualizing the videoconference system as an example of the communications system, the videoconference management system as an example of the communication management system, and the videoconference terminal as an example of the communication terminal. That is, the communication terminal and the communication management system utilized in this embodiment may be applied not only to the videoconference system, but may also be applied to the communication system.

As illustrated in FIG. 1, the communication system 1 includes two or more communication terminals (10aa, 10ab, . . . ), displays (120aa, 120ab, . . . ) for the communication terminals (10aa, 10ab, . . . ), two or more relay devices (30a, 30b, 30c, and 30d), a communication management system 50, a program providing system 90, and a maintenance system 100.

Note that in this embodiment, any one of the communication terminals (10aa, 10ab, . . . ) may be referred to as a “communication terminal 10”, any one of the displays (120aa, 120ab, . . . ) for the communication terminals (10aa, 10ab, . . . ) may be referred to as a “display 120”, and any one of the relay devices (30a, 30b, 30c, and 30d) may be referred to as a “relay device 30”.

The communication terminal 10 is configured to transmit and receive image data and audio data as examples of content data. Note that in the following, the “communication terminal” and the “communication management system” may be simply called the “terminal” and the “management system”, respectively. The communications in this embodiment not only include transmission and reception of audio data but also include transmission and reception of image data. That is, the transmission terminal 10 transmits and receives image data and audio data. However, the transmission terminal 10 may transmit and receive the audio data alone without transmitting or receiving the image data.

In this embodiment, dynamic image data (i.e., video data) are illustrated as an example of the image data; however, the image data may also be static image data. In addition, the image data may include both the dynamic and the static image data. The relay device 30 is configured to relay the image data and the audio data among the terminals 10. The management system 50 is configured to manage the terminal 10 and the relay device 30 in an integrated fashion.

Routers (70a, 70b, 70c, 70d, 70d, 70ab, and 70cd) depicted in FIG. 1 are configured to select optimal paths for the image data and the audio data. Note that in this embodiment, any one of the routers (70a, 70b, 70c, 70d, 70d, 70ab, and 70cd) may be simply called a “router 70”.

The program providing system 90 includes a not-illustrated hard disk (HD) configured or designed to store programs for a terminal, with which the terminal 10 may implement various functions or various methods. Accordingly, the program providing system 90 may transmit such programs for the terminal to the terminal 10. The HD of the program providing system 90 further stores programs for a relay device, with which the relay device 30 may implement various functions or various methods. Accordingly, the program providing system 90 may also transmit such programs for the relay device to the relay device 30. In addition, the HD of the program providing system 90 further stores communication management programs, with which the management system 50 may implement various functions or various methods. Accordingly, the program providing system 90 may also transmit such communication management programs to the management system 50.

The maintenance system 100 is a computer configured to maintain or manage at least one of the terminal 10, the relay device 30, the management system 50, and the program providing system 90. For example, if the maintenance system 100 is domestically located while the terminal 10, the relay device 30, the management system 50 or the program providing system 90 is located abroad, the maintenance system 100 remotely maintains or manages at least one of the terminal 10, the relay device 30, the management system 50, and the program providing system 90 via a communication network 2. Further, the maintenance system 100 performs maintenance, such as the management of a model number, a manufacturer's serial number, a sales destination, a maintenance inspection, and a failure history, on at least one of the terminal 10, the relay device 30, the management system 50, and the program providing system 90 without utilizing the communication network 2.

The terminals (10aa, 10ab, 10ac, 10a . . .), the relay device 30a and the router 70a are connected via a LAN 2a so that they may communicate with one another. Further, the terminals (10ba, 10bb, 10bc, 10b . . .), the relay device 30b and the router 70b are connected via a LAN 2b so that they may communicate with one another. As illustrated in FIG. 1, the LAN 2a and LAN 2b are set up in a predetermined region A. In the region A, the LAN 2a and LAN 2b are connected via a dedicated line tab including the router 70ab so that the LANs may communicate with one another. For example, the region A may be Japan, and the LAN 2a may be set up in the Tokyo Office, whereas the LAN 2b may be set up in the Osaka Office.

Meanwhile, the terminals (10ca, 10cb, 10cc, 10c . . .), the relay device 30c and the router 70c are connected via a LAN 2c so that they may communicate with one another. The terminals (10da, 10db, 10dc, 10d . . .), the relay device 30d and the router 70d are connected via a LAN 2d so that the terminals may communicate with one another. Further, the LAN 2c and LAN 2d are set up in a predetermined region B. In the region B, the LAN 2c and LAN 2d are connected via a dedicated line 2cd including the router 70cd so that the LANs may communicate with one another. For example, the region B may be USA, and the LAN 2c may be set up in the New York Office, whereas the LAN 2d may be set up in the Washington, D.C. Office. The region A and the region B are connected from the respective routers 70ab and 70cd via the Internet 2i so that the region A and the region B are mutually in communication via the Internet 2i.

Further, the management system 50 and the program providing system 90 are connected to the terminal 10 and the relay device 30 via the Internet 2i so that each of these devices may communicate with one another. The management system 50 and the program providing system 90 may be located in the region A or the region B, or may be a region other than the regions A and B.

Note that in this embodiment, the communication network 2 is made up of the LAN 2a, the LAN 2b, the dedicated line 2ab, the Internet 2i, the dedicated line 2cd, the LAN 2c and the LAN 2d. In the communication network 2, the communications are typically carried out via wires, but may partially carried out wirelessly.

In FIG. 1, the set of four numerals attached beneath each of the terminal 10, the relay device 30, the management system 50, the router 70, the program providing system 90, and the maintenance system 100 simply indicates the IP address in a typical IPv4 based system. For example, the IP address for the terminal 10aa is “1.2.1.3”, as illustrated in FIG. 1. The IP addresses may be the IPv6; however, in this embodiment, the IPv4 is used for simplifying the illustration.

### [Hardware Configuration of Embodiment]

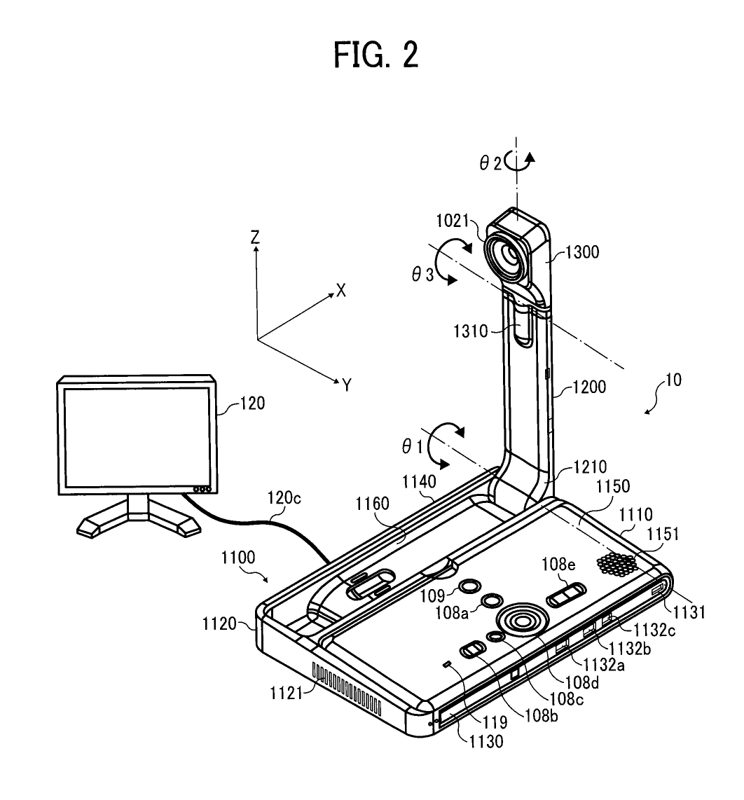

Next, the hardware configuration of the transmission system 1 according to the embodiment is described. FIG. 2 is an external diagram illustrating the terminal 10 according to the embodiment. Hereinafter, an X-axis direction represents a longitudinal direction of the terminal 10, a Y-axis direction represents a direction perpendicular to the X-axis direction in a horizontal plane, and a Z-axis direction represents a direction perpendicular to the X-axis direction and the Y-axis direction (i.e., vertical direction).

As illustrated in FIG. 2, the terminal 10 includes a case 1120, an arm 1200 and a camera housing 1300. A front-wall face 1120a of the case 1120 includes a not-illustrated air-intake face formed of air-intake holes and a rear-wall face 1120b of the case 1120 includes an exhaust face 1121 formed of exhaust holes. Accordingly, the terminal 10 may take in external air behind the terminal 10 via the air-intake face and exhaust the air inside the terminal 10 via the exhaust face 1121 by driving a cooling fan arranged inside the case 1120. A right-wall face 1130 of the case 1120 includes a sound collecting hole 1131, via which a build-in microphone 114 (see FIG. 2) is capable of picking up audio sound such as voice, sound, or noise.

The right-wall face 1130 of the case 1120 includes an operations panel 1150. The operations panel 1150 includes operations buttons (108a to 108e), a later-described power switch 109, a later-described alarm lamp 119, and a sound output face 1151 formed of sound output holes for outputting sound from a later-described built-in speaker 115. Further, a left-wall face 1140 of the case 1120 includes a recessed seating unit 1160 for accommodating an arm 1200 and an operations panel 1200. The right-wall face 1130 of the case 1120 further includes connecting ports (1132a to 1132c) for electrically connecting cables to a later-described external device connecting IF 118. The left-wall face 1140 of the case 1120 further includes a not-illustrated connecting port for electrically connecting a display cable 120c cable to the later-described external device connecting IF 118.

Note that hereinafter, any one of the operations buttons (108a to 108e) may be called an “operations button 108” and any one of the connecting ports (1132a to 1132c) may be called a “connecting port 1132”.

Next, the arm 1200 is attached to the case 1120 via a torque hinge 1210 such that the arm 1200 moves in upward and downward directions within a tilt-angle θ1 range of 135 degrees with respect to the case 1120. The arm 1200 illustrated in FIG. 2 is arranged at a tilt-angle θ1 of 90 degrees.

The camera housing 1300 includes a later-described camera 112 configured to take images of a user, documents, a room, and the like. The camera housing 1300 further includes a torque hinge 1310. The camera housing 1300 is attached to the arm 1200 via the torque hinge 1310. The camera housing 1300 is rotationally attached to the arm 1200 in the upward and downward directions via the torque hinge 1310 such that the camera housing 1300 moves in a pan-angle θ2 range of +−180 degrees and a tilt-angle θ3 range of +−45 degrees based on the pan and tilt angles illustrated in FIG. 2 are both 0.

Note that external appearances of the relay device 30, the management system 50, the program providing system 90, and the maintenance system 100 are all similar to a typical server computer, and their descriptions are therefore omitted.

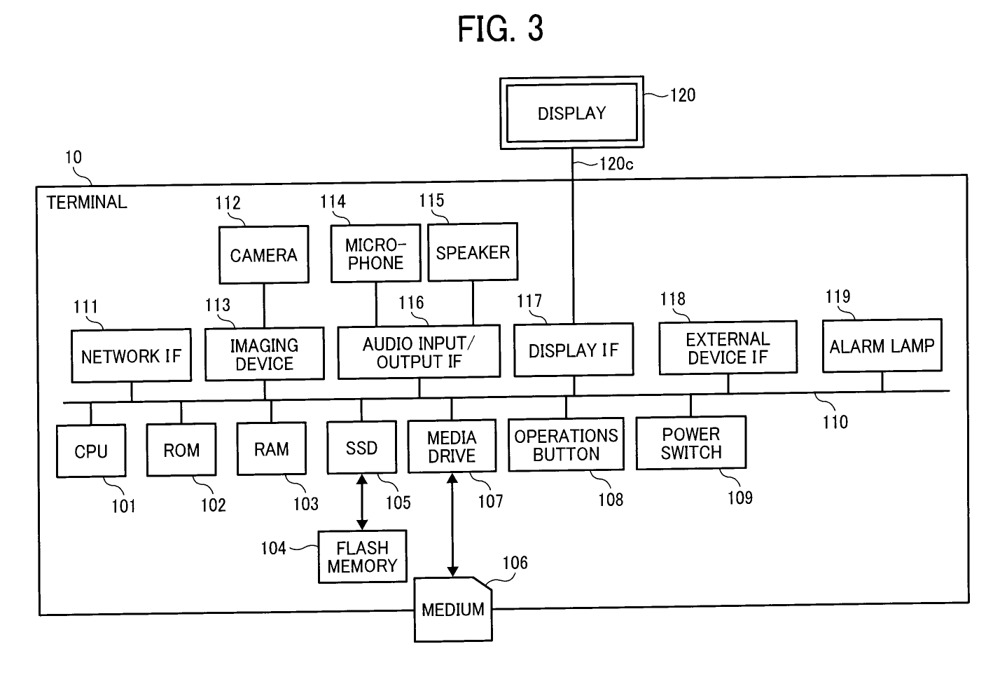

FIG. 3 is a hardware configuration diagram illustrating the terminal (i.e., transmission terminal) 10 according to an embodiment. As illustrated in FIG. 3, the terminal 10 includes a central processing unit (CPU) 101 (circuitry) configured to control overall operations of the terminal 10, a read only memory (ROM) 102 storing programs for the terminal, a random access memory (RAM) 103 utilized as a work area of the CPU 101, a flash memory 104 configured to store various data such as image data or sound data, a solid state drive (SDD) 105 configured to control retrieval and writing (storing) of the various data in the flash memory 104 and the like based on the control of the CPU 101, a media drive 107 configured to control retrieval and writing (storing) of data into a recording medium 106 such as a flash memory, the operations button 108 operated by a user for selecting an address of the terminal 10, the power switch 109 for switching ON/OFF of the power of the terminal 10, and a network interface (IF) for transmitting data utilizing the communication network 2.

The terminal 10 further includes the built-in camera 112 configured to image a subject based on the control of the CPU 101, an imaging device IF 113 configured to control driving of the camera 112, the built-in speaker 115 configured to output sound, a sound input/output IF 116 configured to process input and output of sound signal transmitted between the built-in microphone 114 and the built-in speaker 115, a display IF 117 configured to output image data to the external display 120 based on the control of the CPU 101, the external device connecting IF 118 configured to connect various external devices to the connecting ports, the alarm lamp 119 configured to inform the user of various functional problems of the terminal 10, and a bus line 110 such as an address bus or a data bus for electrically connecting the elements and devices with one another illustrated in FIG. 3 via the bus line 110.

The display 120 is a display unit formed of liquid crystal or an organic EL material configured to display images of the subject or icons for operating the terminal 10. Further, the display 120 is connected to the display IF 117 via the cable 120c (see FIG. 37). The cable 120c may be an analog RGB (VGA) cable, a component video cable, a high-definition multimedia interface (HDMI: High-Definition Multiple Interface: Registered Trademark) cable or a digital video interface (DVI) cable.

The camera 112 includes lenses and a solid-state image sensor configured to convert light into electric charges to produce digital images (videos) of the subject. Examples of the solid-state image sensor include a complementary metal oxide semiconductor (CMOS) or a charge coupled device (CCD).

The external device connecting IF 118 may be connected via a universal serial bus (USB) with external devices such as the external camera, the external microphone, and the external speaker. On connecting the external camera to the external device connecting IF 118 via the USB, the external camera is driven in priority to the built-in camera 112. Likewise, on connecting the external microphone or external speaker to the external device connecting IF 118 via the USB, the external microphone or external speaker is driven in priority to the built-in microphone 114 or the built-in speaker 115.

Note that the recording medium 106 is removable from the terminal 10. In addition, if the recording medium 106 is a non-volatile memory configured to retrieve or write data based on the control of the CPU 101, the recording medium 106 is not limited to the flash memory 104, and may be an electrically erasable and programmable ROM (EEPROM).

Further, the aforementioned programs for the terminal may be recorded in an installable format or in an executable format on a computer-readable recording medium such as the recording medium 106 to distribute such a recording medium.

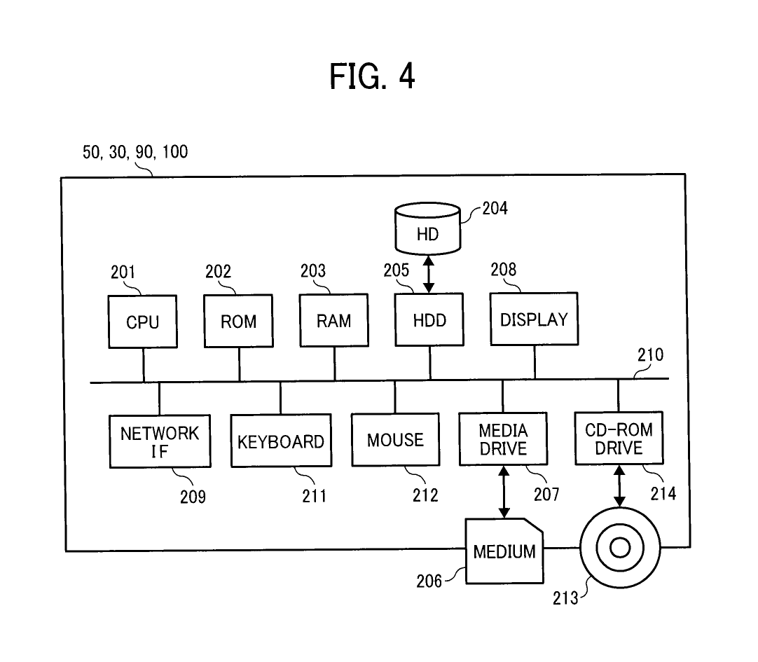

FIG. 4 is a hardware configuration diagram illustrating the management system 50 according to an embodiment. The communication management system 50 includes a central processing unit (CPU) 201 configured to control overall operations of the communication management system 50, a read only memory (ROM) 202 storing programs for the transmission management, a random access memory (RAM) 203 utilized as a work area of the CPU 201, a hard disk (HD) 204 configured to store various data, a hard disk drive (HDD) 205 configured to control retrieval and writing (storing) of the various data in the HD 204 based on the control of the CPU 201, a media drive 207 configured to control retrieval and writing (storing) of data into a recording medium 206 such as a flash memory, a display 208 configured to display various information such as a cursor, menus, windows, characters and images, a network IF 209 for transmitting data utilizing the later-described communication network 2, a keyboard 211 including plural keys for inputting the characters, numerals, and various instructions, a mouse 212 for selecting or executing various instructions, selecting items to be processed, and moving the cursor, a CD-drive 214 configured to control retrieval or writing of data in the compact disk read-only memory (CD-ROM) 213 as an example of a removable recording medium, and a bus line 210 such as an address bus or a data bus for electrically connecting the elements and devices with one another illustrated in FIG. 4 via the bus line 210.

Note that the aforementioned programs for the communication management may be recorded in an installable format or in an executable format on a computer-readable recording medium such as the recording medium 206 or the CD-ROM 213 to distribute such a recording medium.

Further, the relay device 30, the program providing system 90 and the maintenance system 100 include a hardware configuration similar to that of the management system 50, and the description of the hardware configuration of the maintenance system 100 is therefore omitted. Note that the ROM 202 stores programs for controlling the relay device 30, the program providing system 90 and the maintenance system 100. In this case, the relay device 30, the program providing system 90 and the programs for the maintenance system 100 may also be recorded in an installable format or in an executable format on a computer-readable recording medium such as the recording medium 206 or the CD-ROM 213 to distribute such a recording medium.

Note that other examples of the removable recording medium include a compact disc recordable (CD-R), a digital versatile disk (DVD), and a Blu-ray Disc (BD).

### [Functional Configuration of Embodiment]

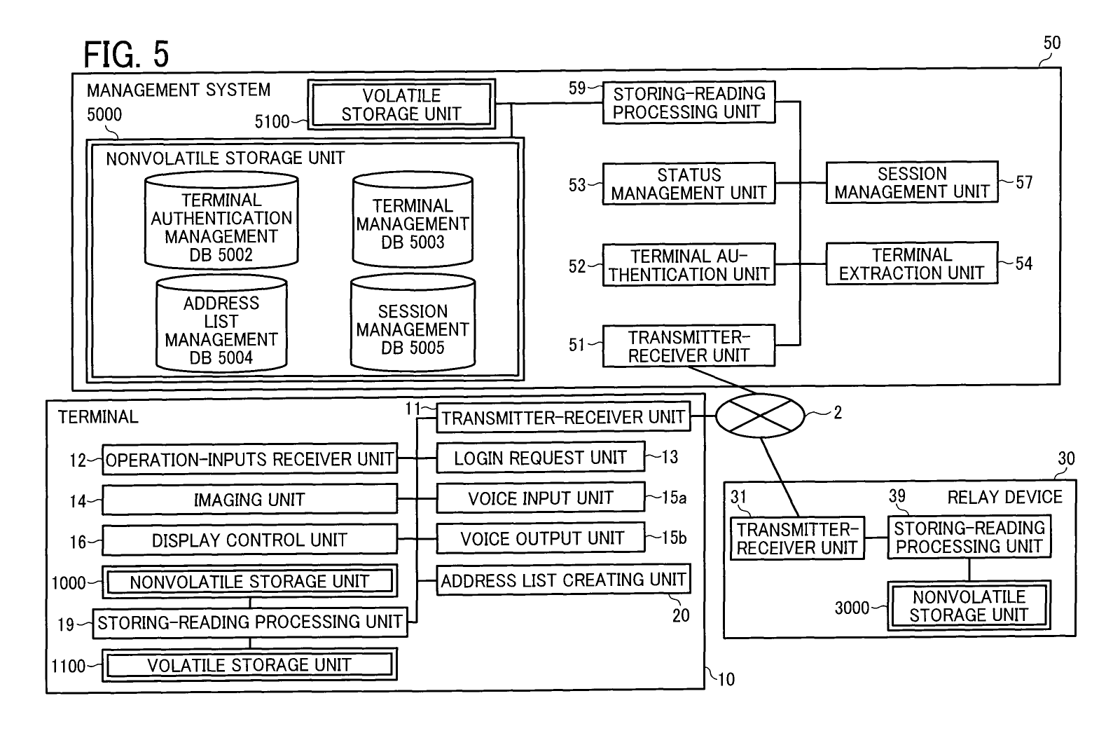

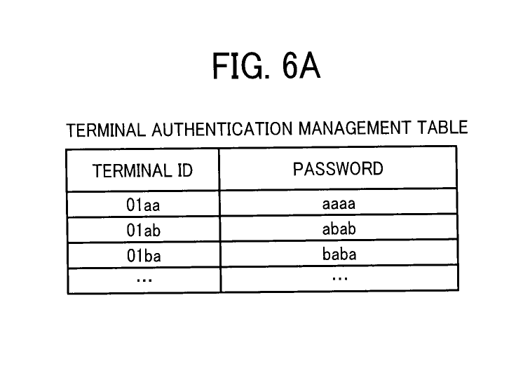

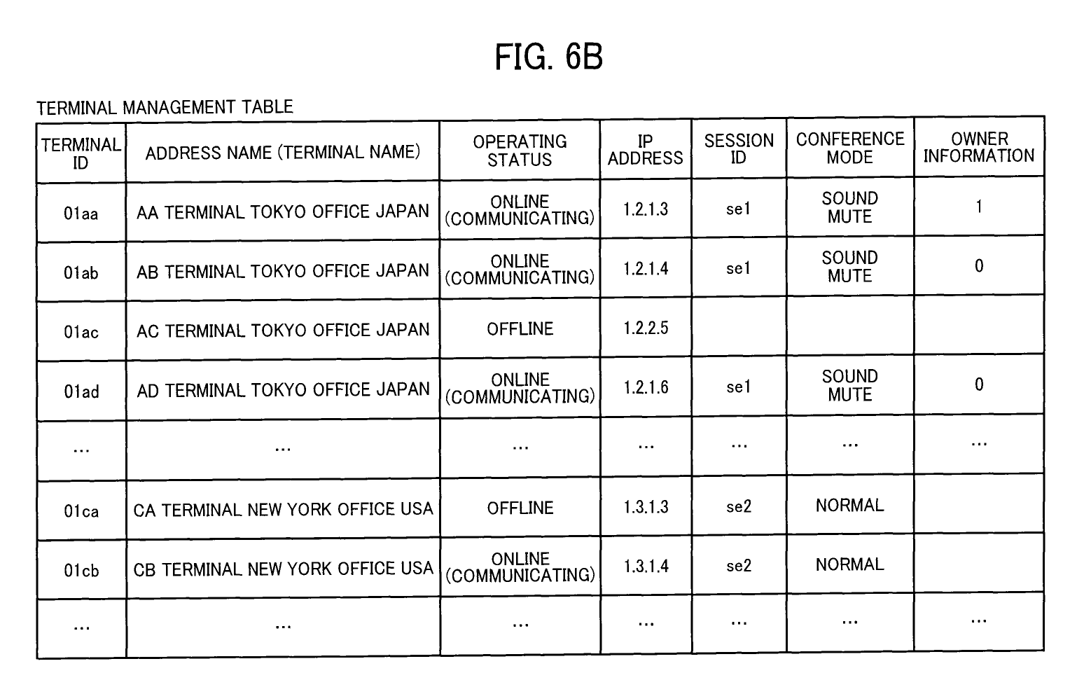

Next, a functional configuration of the communication system 1 according to the embodiment is described. FIG. 5 is a functional block diagram illustrating the transmission terminal 10, the relay device 30, and the manager system 50 that constitute the transmission system 1 according to the embodiment. As illustrated in FIG. 5, the terminal 10, the relay device 30, and the management system 50 are connected via the communication network 2 such that they carry out data communications with one another via the communication network 2. Note that the program providing system 90 and the maintenance system 100 are not directly associated with videoconferencing communications, and their illustrations are therefore omitted from FIG. 5.

### [Functional Configuration of Terminal]

The terminal 10 includes a transmitter-receiver unit 11, an operation-inputs receiver unit 12, a login request unit 13, an imaging unit 14, a sound input unit 15a, a sound output unit 15b, a display control unit 16, a delay detector unit 18, a storing-reading processing unit 19, and an address list creating unit 20. The above units represent functions and units implemented by any of the elements and devices illustrated in FIG. 3, which are activated by instructions from the CPU 201 based on the programs stored in the ROM 102. Further, the terminal 10 further includes a volatile storage unit 1100 formed of the flash memory 104 illustrated in FIG. 2, and a nonvolatile storage unit 1000 formed of the RAM 103 illustrated in FIG. 2.

### [Functional Units of Terminal]

Next, the functional units of the terminal 10 are described in more detail. The transmitter-receiver unit 11 of the terminal 10 is configured to transmit various data (information) to and receive such data from other terminals, relay devices, and systems.

The operation-inputs receiver unit 12 is configured to receive various inputs from the user, and such a function of the operation-inputs receiver unit 12 is implemented by the operations button 108 and the power switch 109. For example, when the user switches ON the power switch 109, the operation-inputs receiver unit 12 receives a power-ON signal to switch ON the power of the terminal 10.

The login request unit 13 is configured to automatically transmit login request information indicating that the user desires to login, and a current IP address of the terminal 10 as an IP address of a request source terminal from the transmitter-receiver unit 11 to the management system 50 via the communication network 2 when the power-ON signal is received by the operation-inputs receiver unit 12 as a trigger. Such a function of the login request unit 13 is implemented by instructions received from the CPU 101 illustrated in FIG. 2. On the other hand, when the user switches OFF the power switch 109, the transmitter-receiver unit 11 transmits power off status information to the management system 50, and the operation-inputs receiver unit 12 subsequently turns OFF the power of the terminal 10 completely. Accordingly, the management system 50 may detect a power status of the terminal 10 as an OFF status.

The imaging unit 14 is configured to take an image of a subject and output image data of the subject, and such a function of the imaging unit 14 is implemented by instructions received from the CPU 101, and also by the camera 112 and the imaging device IF 113. The sound input unit 15a is configured to input sound data of the sound signal obtained by the microphone 114 that converts sound of the user into the sound signal, and such a function of the sound input unit 15a is implemented by the sound input/output IF 116. The sound output unit 15b is configured to output sound signal related to the sound data to a speaker 115, and such function of the sound output unit 15b is implemented by the sound input/output IF 116.

The display control unit 16 is configured to control transmission of the image data to the external display 120, and such a function of the display control unit 16 may be implemented by the network IF 117 illustrated in FIG. 2.

The storing-reading processing unit 19 is configured to store various data in a nonvolatile storage unit 1000 or retrieve various data from the nonvolatile storage unit 1000, and such a function of the storing-reading processing unit 19 may be implemented by instructions received from the CPU 101 and also by the SSD 105 illustrated as an example in FIG. 2. The nonvolatile storage unit 1000 stores a terminal identification (ID), and a password, and the like for identifying the terminal 10. The storing-reading processing unit 19 is configured to further store various data in the volatile storage unit 1100 and retrieve various data from the volatile storage unit 1100. The storing-reading processing unit 19 overwrites the image data and the sound data in the volatile storage unit 1100 with new data received from the destination terminal every time the terminal 10 communicates with the destination terminals. Note that the display 120 displays previous image data before being overwritten with the new image data and the speaker 115 outputs previous sound data before being overwritten with the new sound data.

The address list creating unit 20 is configured to create and update an address list which display statuses of the destination candidates with icons based on the later-described address list information and the status information of the terminal 10 as a destination candidate.

Note that the terminal ID and the later-described relay device ID individually indicate identification information formed of language, characters, and various symbols that uniquely identify the terminal and the relay device. The terminal ID and the relay device ID may be the identification information formed of a combination of two or more of the languages, characters, and various symbols.

### (Functional Configuration of Relay Device)

Next, functions and units of the relay device 30 are described. As illustrated as an example in FIG. 4, the relay device 30 includes a transmitter-receiver unit 31, a status detector unit 32, a data quality checker unit 33, an alteration quality management unit 34, a data quality alteration unit 35, and a storing-reading processing unit 39. The above units represent functions and units implemented by any of the elements and devices illustrated in FIG. 4, which are activated by instructions from the CPU 201 based on the programs stored in the ROM 202. Further, the relay device 30 further includes a nonvolatile storage unit 3000 formed of the HD 204 illustrated in FIG. 4, which is capable of maintaining the various data or information even when the power of the relay device 30 is turned off

### [Functional Units of Relay Device]

Next, the functional configuration of the relay device 30 is described. Note that in the following description, the functions of the relay device 30 are illustrated in association with the main elements and devices for implementing the units of the relay device 30 illustrated in FIG. 4.

The transmitter-receiver unit 31 of the relay device 30 is configured to transmit various data (information) to and receive such data from other terminals, relay devices and systems. The function of the transmitter-receiver unit 31 may be implemented by the network IF 209. The storing-reading processing unit 39 which is activated by instructions from the CPU 201 is configured to store various data in the nonvolatile storage unit 3000 and retrieve various data from the nonvolatile storage unit 3000.

### [Functional Configuration of Management System]

Next, functions and units of the management system 50 are described. The management system 50 includes a transmitter-receiver unit 51, a terminal authentication unit 52, a terminal management unit 53, a terminal extraction unit 54, a session management unit 57 and a storing-reading processing unit 59.

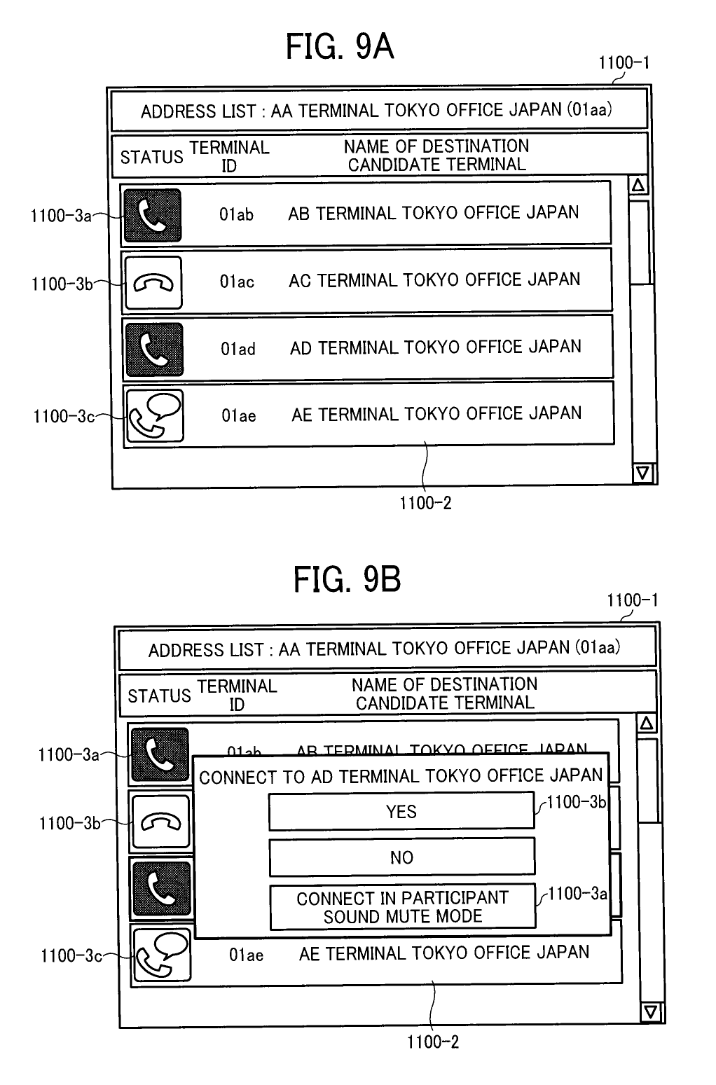

The above units represent functions and units implemented by any of the elements and devices illustrated in FIG. 4, which are activated by instructions from the CPU 201 based on the programs stored in the ROM 202. Further, the management system 50 further includes a nonvolatile storage unit 5000 formed of the HD 204, which is capable of maintaining the various data or information even when the power of the management system 50 is turned off. For example, the nonvolatile storage unit 5000 stores an address list frame 1100-1 illustrated in FIGS. 9A-B. The management system 50 may include a volatile storage unit 5100 formed of the RAM 203.

### (Authentication Management Table)

The nonvolatile storage unit 5000 includes a terminal authentication management DB 5002 formed of a terminal authentication management table illustrated in FIG. 6(A). In the terminal authentication management table, passwords are individually associated with the terminal IDs of all the terminals managed by the management system 50.

### (Terminal Management Table)

The nonvolatile storage unit 5000 includes a terminal management DB 5003 formed of a terminal management table illustrated in FIG. 6(B). In the terminal management table, terminal IDs of the terminals 10, operating as destination terminals, are associated with terminal names of the destination terminals 10, operating statuses of the destination terminals 10, and IP addresses of the destination terminals 10. Further, in the terminal management table, terminal IDs of the terminals 10 having an operating status “ON line (communicating)” are associated with session IDs of the content data sessions “sed” and a conference mode. The conference mode includes a “normal” mode and a “sound mute” mode. The “normal” mode is a mode without restriction on transmission of the sound data from each participant terminal 10 participating in the content data session “sed”. And the “sound mute” mode is a mode with restrictions on transmission of the sound data from at least one participant terminal 10. Furthermore, in the terminal management table, terminal IDs of the terminals 10 having a conference mode “sound mute” mode are associated with owner information. Note that the owner information includes value “0” identifying a terminal 10 that is a member of the conference or value “1” identifying a terminal 10 that is an owner of the conference. Note that the terminal 10 as the owner of the conference has authority for transmitting the image data and the sound data to the other terminals 10. Furthermore, the at least one terminal that is a member of the conference has authority for transmitting the image data but is restricted for transmitting the sound data.

### (Terminal List Management Table)

The nonvolatile storage unit 5000 includes an address list management DB 5004 formed of an address list management table illustrated in FIG. 6(C). In the address list management table, terminal IDs of registered destination candidate terminals are associated with the terminal IDs of the request source terminals that request initiation of a videoconference communication. For example, in the address list management table illustrated in FIG. 6(C), the terminal ID “01aa” of the request source terminal 10aa is associated with a destination candidate terminal 10ab having a terminal ID “01ab”, a destination candidate terminal 10ac having a terminal ID “01ac”, which the request source terminal requests to initiate the videoconference.

### (Session Management Table)

The nonvolatile storage unit 5000 includes a session management DB 5005 formed of a session management table illustrated in FIG. 6(D). In the session management table, session IDs that identify sessions in which the communication data are transmitted and received between the terminals are associated with the relay device IDs of the relay devices 30 utilized for relaying the image data and the sound data.

### (Functional Units of Management System)

Next, functional units of the management system 50 are described. Note that in the following description, the functions of the management system 50 are illustrated in association with the main elements and devices for implementing the units of the management system 50 illustrated in FIG. 4.

The transmitter-receiver unit 51 of the management system 50 is configured to transmit various data (information) to and receive such data from other terminals, relay devices, and systems. The function of the transmitter-receiver unit 51 may be implemented by the network IF 209. The terminal authentication unit 52 is configured to search the authentication management table (see FIG. 6(A)) of the nonvolatile storage unit 5000 by the terminal ID and a password contained in the login request information as search keys, and authenticate the corresponding terminal based on whether the terminal ID and the password contained in the login request are identical to those managed in the authentication management table.

The terminal management unit 53 which is activated by instructions from the CPU 201 is configured to manage the terminal management table (see FIG. 6(B)) by associating the terminal ID of the request source terminal, the operating status of the request source terminal and the IP address of the request source terminal. The terminal management unit 53 searches the terminal management table with the terminal ID as a search key and reads the operation status and so on of the searched terminal ID.

The terminal extraction unit 54 is configured to retrieve various data in each DB formed in the nonvolatile storage unit 5000. Such a function of the terminal extraction unit 54 is implemented by instructions received from the CPU 101.

The session management unit 57 is configured to generate a session ID to identify the session transmitting the content data during the terminals 10. The session management unit 57 is configured to choose the relay device 30 relaying the content data within the session among a plurality of relay devices. The session management unit 57 is configured to store and manage the session IDs in association with the terminal ID of the request source terminal and the terminal ID of the destination terminal in the session management table (see FIG. 6(D)) of the nonvolatile storage unit 5000. Such a function of the session management unit 57 is implemented by instructions received from the CPU 101. The storing-reading processing unit 59 stores various data in the nonvolatile storage unit 5000 and reads various data stored in the nonvolatile storage unit 5000. Such a function of the storing-reading processing unit 59 is implemented by instruction received from the CPU 101.

### [Process and Operation]

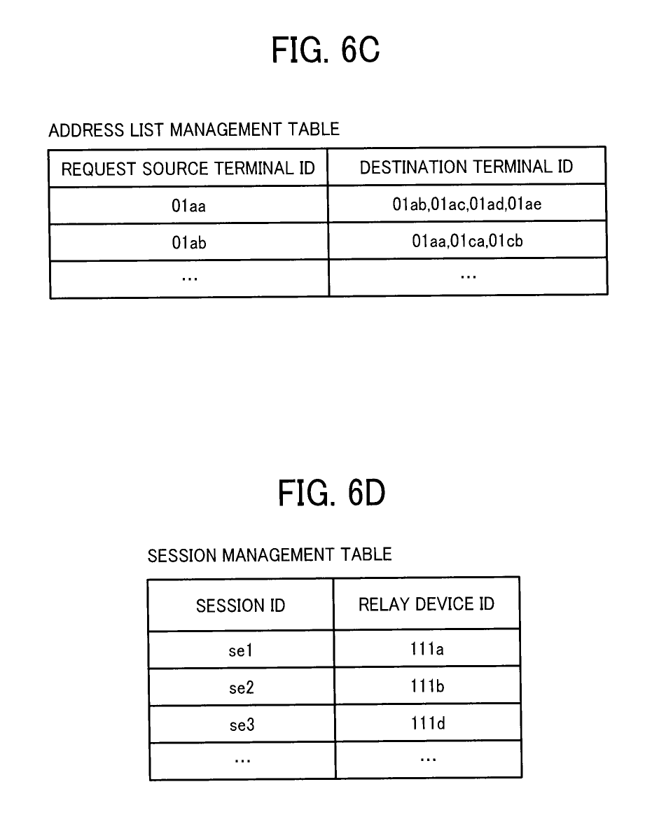

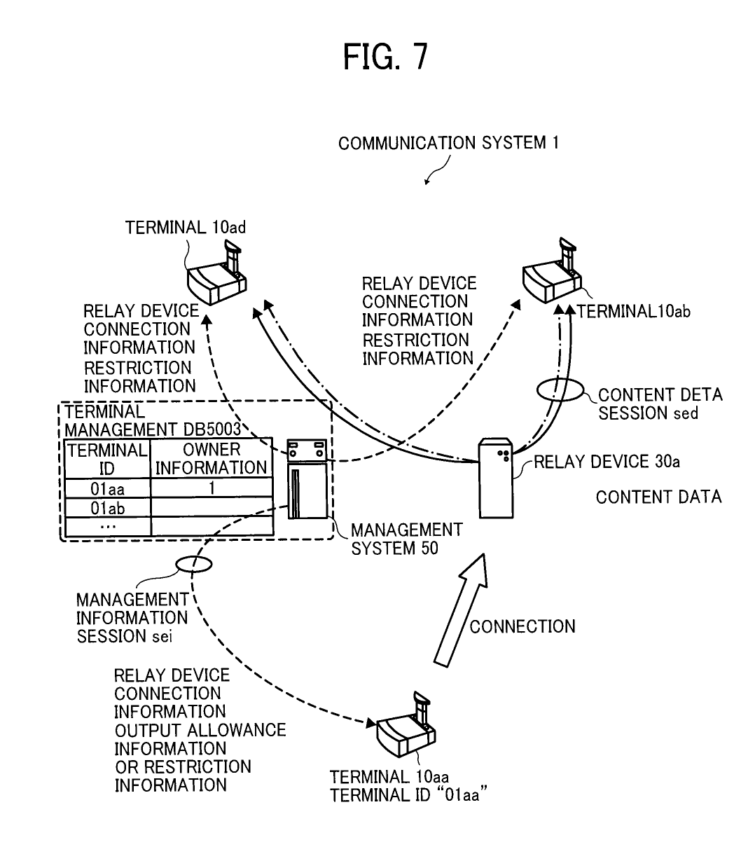

So far, the configuration and functions (units) of the communication system 1 according to the embodiment are described, and processes and operations carried out by the communication system 1 according to the embodiment are subsequently described. In using FIG. 7, an outline of the processes and operations according to the embodiment is described. Note that FIG. 7 is a conceptual diagram illustrating transmitting and receiving statuses of image data, sound data and various management information in the communication system 1.

When the transmitting is performed in the content data session “sed” the sound data from the one or more terminals is restricted and the terminal manage DB 5003 stores and manages owner information identifying the terminal 10aa that is not restricted and that transmits the sound data. When the terminal 10aa participating in the content data session “sed” is identified as the owner terminal 10a based on the owner information, the management system 50 does not restrict transmitting of the sound data from the terminal 10aa. On the other hand, when the terminal 10aa participating in the content data session “sed” is not identified as the terminal 10 based on the owner information, the transmitter-receiver 51 transmits restriction request information to the terminal 10aa. As a result, transmitting of the sound data from the terminal 10aa is controlled to be restricted based on the restriction request information. In addition, when the owner terminal 10 that had left the content data session “sed” rejoins content data session “sed” again, it is possible to control the transmitting of the sound data from the owner terminal 10 rejoining in the content data session “sed”, based on the owner information stored and managed in the terminal management DB 5003.

Note that the terminal 10 is equipped with the microphone 114 generating the sound data based on input sound. The transmitter-receiver 11 of the terminal 10 receives the restriction request information transmitted from the management system 50. In response to receiving the restriction request information, the sound input unit 15a of the terminal 10 restricts generating of the sound data based on the sound input from the microphone 114.

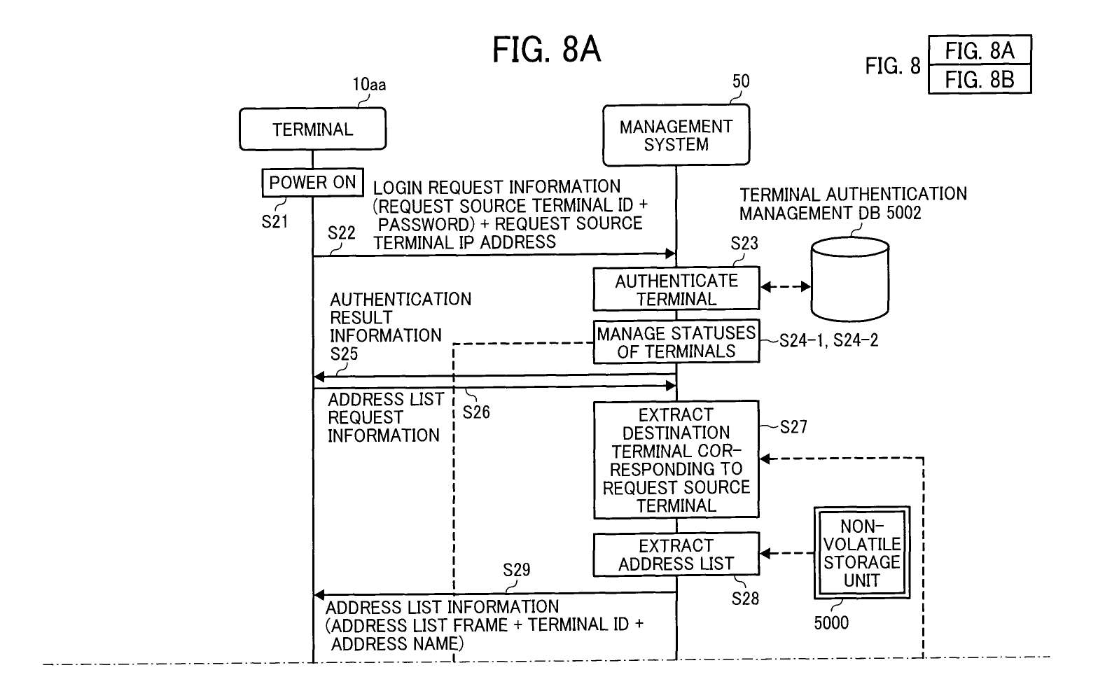

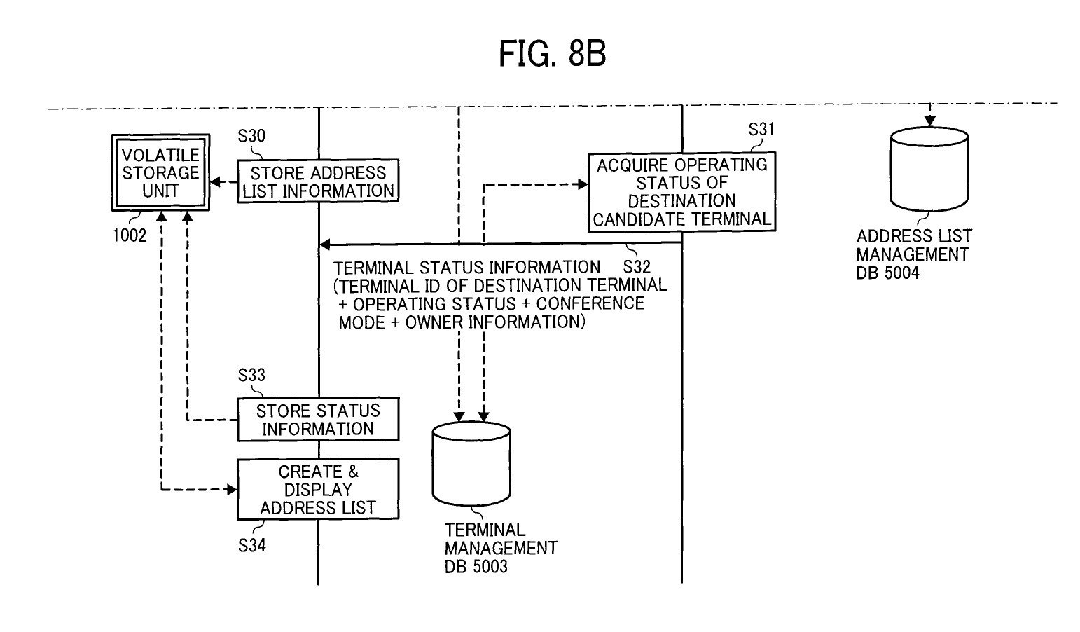

Next, the process carried out by the communication system 1 according to the embodiment is described in detail. FIGS. 8A-B is a sequence diagram illustrating a process of a preparatory phase when the terminals initiate the communication. A process in which each of the management information items is transmitted and received in a preparatory phase before the terminal 10aa initiates the communication is described with reference to FIGS. 8A-B. Note that FIGS. 8A-B illustrate a process in which various management information items are all transmitted and received in the management information sessions “sei”.

First, when the user of the terminal 10aa switches ON the power switch 109 illustrated in FIG. 2, the operation-inputs receiver unit 12 illustrated in FIG. 4 receives a power-ON signal to switch ON the power of the terminal 10aa (step S21). On receiving the power-ON signal as a trigger, the login request unit 13 automatically transmits the login request information indicating the login request from the transmitter-receiver unit 11 to the management system 50 via the communication network 2 (step S22). The login request information includes a terminal ID and a password for identifying the terminal 10aa. The terminal ID and password are data that are retrieved from the nonvolatile storage unit 1000 by the storing-reading processing unit 19 and are then transmitted to the transmitter-receiver unit 11. Note that when the login request information is transmitted from the terminal 10aa to the management system 50, the receiver side management system 50 may detect the IP address of the transmitter side terminal 10aa.

Next, the terminal authentication unit 52 of the management system 50 authenticates the terminal 10aa based on whether the ID and password are identical to those in the login request information managed in the terminal authentication management DB 5002 of the nonvolatile storage unit 5000 by searching for the ID and password as search keys in the terminal authentication management table (see FIG. 6(A)) (step S23).

The terminal authentication unit 52 manages terminal IDs and passwords. Accordingly, when the terminal authentication unit 52 determines that the received login request comes from the terminal 10aa having a valid access authorization, the terminal management unit 53 stores the receipt time and date of the received login information and the IP address of the terminal 10aa in association with the record presented by the terminal ID and the destination name of the terminal 10aa in the terminal management table (see FIG. 6(B)) (step S24-1). Thus, the terminal IP address “1.2.1.3” is managed in association with the terminal ID “10aa” in the terminal management table illustrated in FIG. 6(B).

Subsequently, the status setting unit 53a of the terminal management unit 53 sets the operating status “ONLINE” of the terminal 10aa and stores the set operating status in association with the record presented by the terminal ID and the destination name of the terminal 10aa in the terminal management table (see FIG. 6(B)) (step S24-2).

The transmitter-receiver unit 51 of the management system 50 transmits authentication result information indicating authentication result acquired by the terminal authentication unit 52 via the communication network 2 to the request source terminal (i.e., terminal 10aa) that has requested the login request (step S25). In the following, the case where the terminal authentication unit 52 has determined that the terminal has the valid access authorization is further described.

When the terminal 10aa receives the determined result indicating that the terminal 10aa has the valid access authorization, the transmitter-receiver unit 11 of the terminal 10aa transmits address list request information indicating an address list request to the management system 50 via the communication network 2 (step S26). The transmitter-receiver unit 51 of the management system 50 then receives the address list request information.

Next, the terminal extraction unit 54 searches the address list management table (see FIG. 6(C)) by the terminal ID (01aa) of the request source terminal (i.e., terminal 10aa) that has requested the address list, and retrieves the terminal IDs of the destination candidate terminals capable of communicating with the requesting source terminal (i.e., terminal 10aa). As a result, the terminal extraction unit 54 extracts the terminal IDs of the destination candidate terminals capable of communicating with the requesting source terminal (step S27). In addition, the terminal status acquisition unit 54 searches the terminal management table (see FIG. 6(B)) by the terminal IDs of the destination candidate terminals extracted by the terminal extraction unit 54 as search keys, and retrieves the destination names corresponding to the terminal IDs of the destination candidate terminals. In this example, terminal IDs (01ab, 01ac, . . . ) of the destination terminals (10ab, 10ac, . . . ) associated with the terminal ID “01aa” of the request source terminal (i.e., terminal 10aa) and terminal names (AB TERMINAL TOKYO OFFICE JAPAN, AC TERMINAL TOKYO OFFICE JAPAN) corresponding to the terminal IDs (01ab, 01ac, . . . ) of the destination terminals (10ab, 10ac, . . . ) are extracted.

Next, the transmitter-receiver unit 51 of the management system 50 retrieves data indicated by an address list frame (i.e., data indicated by the address list frame 1100-1 in FIG. 9A-B) from the nonvolatile storage unit 5000 (step S28), and transmits the address list information (address list frame, terminal IDs, address names) including the address list frame, the terminal IDs and the destination names extracted by the terminal extraction unit 54 to the terminal 10aa (step S29). Accordingly, in the terminal 10aa, the transmitter-receiver unit 11 receives the address list information and the storing-reading processing unit 19 stores the address list information in the volatile storage unit 1100 (step S30).

In this embodiment, the address list information is not managed by the terminal 10 but is managed by the management system 50. The management system 50 uniformly manages the address list information of all the terminals in the communication system 1. Thus, even if a new terminal 10 is added to the communication system 1, a new model terminal 10 is replaced with the terminal 10 in the communication system 1, or the appearance of the address list frame is altered, the management system 50 side may handle all the processes concerning these alternations at once so that the terminal 10 side need not carry out the process of changing the address list information.

The terminal management unit 53 of the management system 50 searches the terminal management table (see FIG. 6(B)) by the terminal ID (01ab, 01ac, . . .) of the terminals serving as the destination candidate terminals extracted by the terminal extraction unit 54. The terminal management unit 53 reads the operating status, the communication status, the conference mode and the owner information of each of the terminal IDs extracted by the terminal extraction unit 54 so that the terminal management unit 53 can retrieve the operating status, the communication status, the conference mode and the owner information of the terminal (10ab, 10ac, . . . ) serving as the destination candidate terminals (Step S31).

Next, the transmitter-receiver unit 51 of the management system 50 transmits a terminal status information including the terminal ID (01ab) of the terminal (10ab) serving as the destination candidate terminal, the operating status, the conference mode and the owner information of the terminal (10ab), to the terminal 10aa via the communication network (Step S32). And the transmitter-receiver unit 51 transmits a terminal status information including the terminal ID (01ac) of the terminal (10ac) serving as the destination candidate terminal, the operating status, the communication status, the presenter information and the restriction information of the terminal (10ac), to the terminal 10aa.

Next, the storing-reading processing unit 19 stores the terminal status information received from the management system 50 in the volatile storage unit 1100 (Step S33). Accordingly, the terminal 10aa can retrieve the operating status of the terminal (10ac) serving as the destination candidate terminals that are able to communicate with the terminal 10aa.

Next, the address list creating unit 20 of the terminal 10aa creates an address list reflecting the status of the terminal 10 serving as the destination candidate terminal based on the address list information and the status information stored in the volatile storage unit 1100. The display control unit 16 controls a displaying the created address on the display 120aa (Step S34).

As shown in FIG. 9(A), the address list indicating a name of the destination candidate terminal 1100-2 and an icon reflected the status information 1100-3 in the address list frame 1100-1 is displayed on the display 120aa. FIGS. 9A-B are a conceptual diagram illustrating an address list according to an embodiment. The address list frame 1100-1 indicates the names of the destination candidate terminals 1100-2 and the icons (1100-3a, 1100-3b, 1100-3c) reflecting the status information associated with the names of the destination candidate terminals 1100-2. The icon 1100-3a indicates COMMUNICATION OK for the terminal 10ab because a status of the terminal 10ab is ONLINE and WAITING FOR COMMUNICATION. The icon 1100-3b indicates COMMUNICATION NG for the terminal 10ac because a status of the terminal 10ac is OFFLINE. The icon 1100-3c indicates COMMUNICATION OK (communicating) for the terminal 10ae and it is possible for the terminal 10ae to request for participation in the content data session.

### <Start Request>

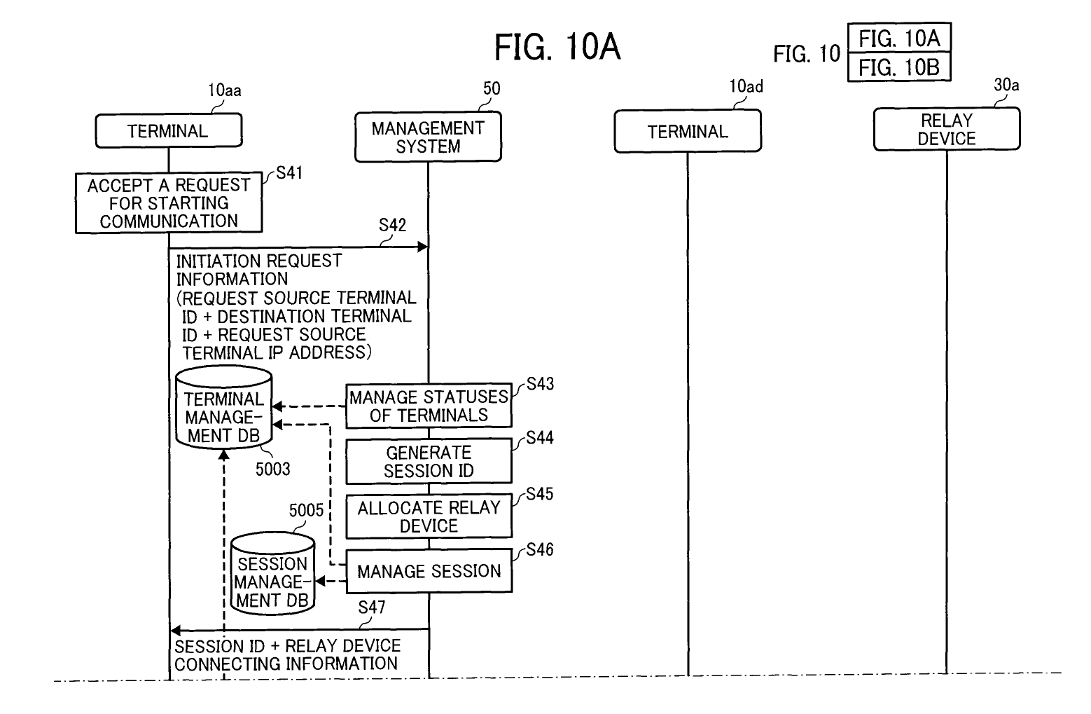

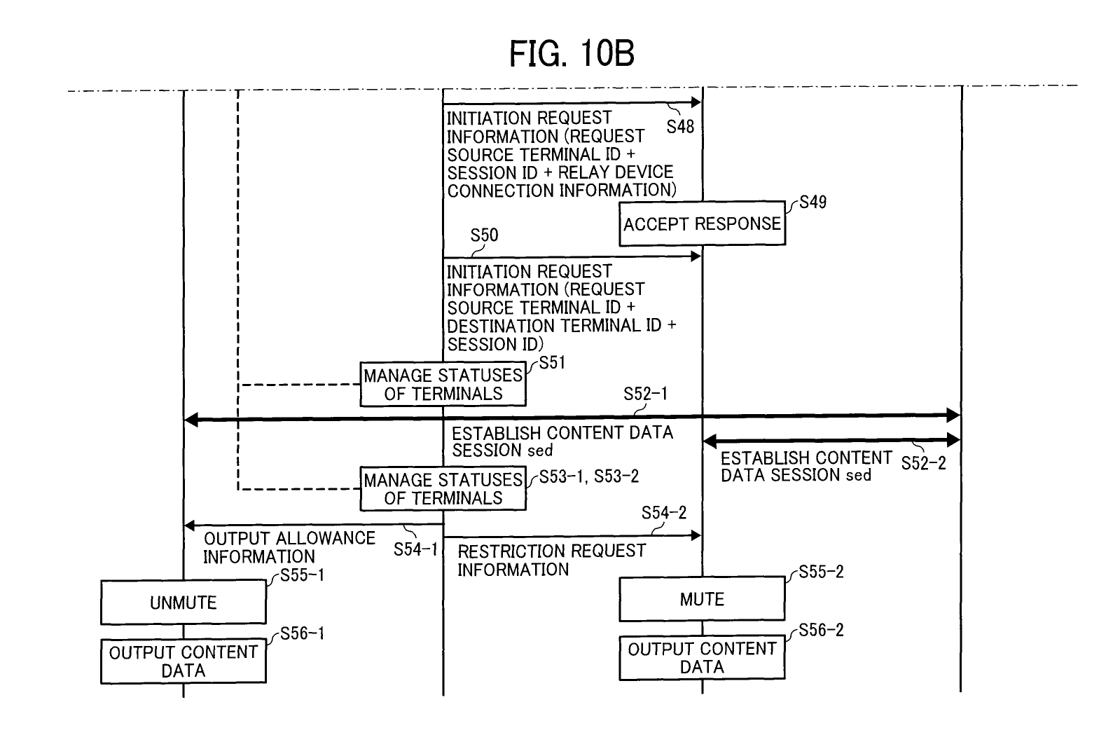

Next, a process for the terminal 10aa to request for delivery of content data will be described using FIGS. 10A-B. For instance, FIGS. 10A-B are a sequence diagram illustrating a process of communication starting at the terminal 10aa. In the process illustrated FIGS. 10A-B, various types of information are transmitted/received in a management information session “sei” without the process of step S52-1, S52-2.

First, when the user of the terminal 10aa presses the operation keys 108 to select the icon associated with the terminal ID (01ad) of the terminal 10ad in the destination candidate terminals (see FIG. 9(A)) displayed on the display 120aa, the operation input acceptor 12 accepts a request for starting communication with the terminal 10aa as the special terminal (Step S41). Next, the display control unit 16 controls to cause keys 1100-3a, 1100-3b, for connecting to the destination terminal illustrated in FIG. 9(B), to be displayed on the display device 120aa. When the key 1100-3a is pressed, the operation-inputs receiver unit 12 accepts initiation request information indicating a request for initiating communication in a mode (a sound mute mode) in which the transmitting the sound data from any participant terminal, except the terminal 10aa itself, participating in the content data session “sed” is restricted.

The data transmitter/receiver 11 of the terminal 10aa transmits, to the management system 50, initiation request information that includes the terminal ID (01aa) of the terminal 10aa serving as a request source terminal, the IP address “1.2.1.3” and the terminal ID (01ad) of the terminal 10ad serving as the destination terminal, the initiation request information that indicates a request for starting communication in the sound mute mode in the content data session “sed” (Step S42).

When the transmitter-receiver unit 51 of the management system 50 receives the initiation request information, the terminal management unit 53 changes to the operating status “ON LINE (COMMUNICATING)”, and changes to the conference mode “SOUND MUTE”.

Next, the session management unit 57 creates a session ID (se1) identifying the content data session “sed” to carry out the communication requested by the terminal 10aa (Step S44).

Next, the session management unit 57 of the management system 50 chooses the relay device 30 relaying the content data within the content data session “sed” created based on the terminal 10aa's request (Step S45). In this embodiment, a situation in which the session management unit 57 selects the relay device 30 is illustrated.

When the session management unit 57 finishes choosing the relay device 30, the session management unit 57 stores the session ID (se1) generated in the process of the Step 44 and the relay device ID (111a) of the relay device 30a chosen by the process of the Step S45 in the session management table (see FIG. 6 (D)) (Step S46).

Next, the transmitter-receiver unit 51 illustrated in the FIG. 5 transmits, the session ID created by the process of the Step S44 and the relay device connection information used in connection with the relay device 30a chosen by the process of the Step 45, to the terminal 10aa via the communication network 2 (Step S47). The IP address “1.2.1.2” of the relay device 30a, authentication information, and a port number and so on may be included in the relay device connection information.

The transmitter-receiver unit 51 transmits the initiation request information and the relay device connecting information to the destination terminal 10ad. This initiation request information, including the terminal ID (01aa) of the terminal 10aa and the session ID (se1), indicates a request for initiating communication in the sound mute mode in which the transmitting of the sound data from any participant terminal, except the terminal 10 serving as the request source terminal, participating in the content data session “sed” is restricted. Furthermore this relay device connecting information is utilized to connect the relay device 30a (Step S48).

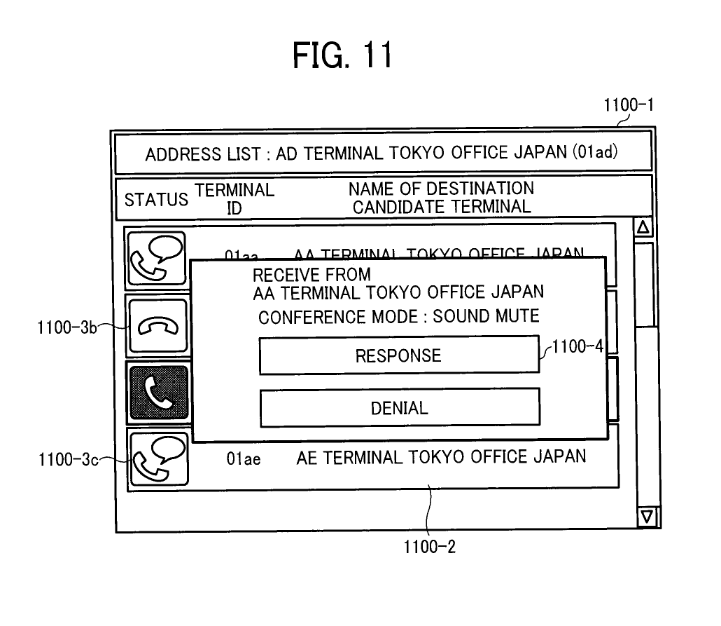

Next, the display control unit 16 of the terminal 10ad controls to cause keys 1100-4, for receiving in the sound mute mode illustrated in FIG. 11, to be displayed on the display device 120aa (Step S49). FIG. 11 is a conceptual diagram illustrating an address list according to an embodiment. When the key 1100-4 is chosen by a user of the terminal 10ad, the operation-inputs receiver unit 12 accepts, as a part of the process of the Step S49, a response indicating permission for initiating the communication with the terminal 10aa in the sound mute mode. Next, the transmitter-receiver 11 of the terminal 10ad transmits initiation response information to the management system 50 (Step S50). The initiation response information includes the terminal ID (01ad) of the destination terminal 10ad, the terminal ID (01aa) of the terminal 10aa serving as the request source terminal, and the session ID (se1).

When the transmitter-receiver 51 of the management system 50 receives this initial response information, the terminal management unit 53 changes to ON in the OPERATING STATUS field of the record indicating terminal ID (01ad) of the terminal 10ad and changes to SOUND MUTE in the CONFERENCE MODE field of the record indicating terminal ID (01ad) of the terminal 10ad in the terminal management table (See FIG. 6(B)) (Step S51).

The transmitter-receiver 11 of the terminal 10aa transmits the session ID (se1) to the relay device 30a in using the received relay device connecting information. The transmitter-receiver 11 of the terminal 10ad transmits the session ID (se1) to the relay device 30a using the received relay device connecting information. Accordingly, the terminal 10aa and the terminal 10ad connect with the relay device 30a and the content data session “sed” is established between the terminal 10aa, the terminal 10ad, and the relay device 30a (Step S52-1, S52-2).

Once the content data session “sed” has been established, the terminal management unit 53 changes to “1” the OWNER INFORMATION field of the record indicating terminal ID (01aa) of the terminal 10aa serving as the request source terminal in the terminal management table (See FIG. 6(B)) (Step S53-1). Furthermore, the terminal management unit 53, as a part of the process of the Step S53, changes to 0 the OWNER INFORMATION field of the record indicating terminal ID (01ad) of the destination terminal 10ad in the terminal management table (See FIG. 6(B)) (Step S53-2).

Next, the transmitter-receiver 51 of the management system 50 transmits output permission information indicating permission for transmitting the image data and the sound data to the terminal 10aa serving as the request source terminal (Step S54-1).

When the transmitter-receiver unit 11 of the terminal 10aa receives the output permission information, an imaging unit 14 starts outputting the image data from the camera 112 and the sound input unit 15a starts outputting the sound data by unmuting the microphone 114 (Step S55-1). The transmitter-receiver unit 11 of the terminal 10aa transmits the output image data and sound data to the relay device 30a within the content data session “sed”. The relay device 30a transmits the received image data and sound data to the terminal 10ad participating in this content data session “sed”. Accordingly, the terminal 10ad receives the image data and sound data sent from the terminal 10aa.

The transmitter-receiver 51 of the management system 50 transmits restriction request information indicating a request for restricting the transmitting of the content data to the terminal 10aa serving as the destination terminal (Step S54-2). The restriction operates by, for example, restricting transmitting of the image data and the sound data, restricting only transmitting of the image data, and restricting only transmitting of the sound data. Below, the restricting only transmitting of the sound data will be illustrated.

When the transmitter-receiver 11 of the terminal 10ad receives the restriction request information, the imaging unit 14 starts outputting the image data while the sound input unit 15a does not start outputting the sound data (the microphone 114 is muted) (Step S55-2). Accordingly, the image data is transmitted from the terminal 10ad and the sound data is not transmitted from the terminal 10ad. The relay device 30b transmits the image data from the terminal 10ad to the terminal 10, that is the terminal 10aa, participating in this content data session so that it is possible for the terminal 10aa to receive the image data from the terminal 10ad.

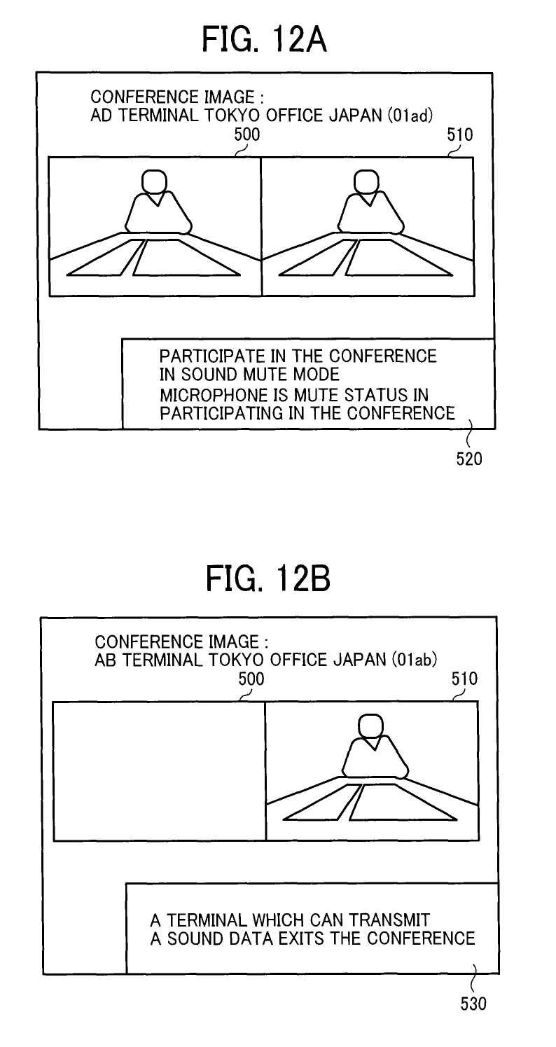

When the transmitter-receiver 11 of the terminal (10aa, 10ad) receives the image data, the image is output from the display 120 based on the received image data by the display control unit 16 (Step S56-1, Step S56-2). Further, the sound is output from the speaker 115 based on the received sound data by the sound output unit 15b of the terminal 10ad. FIG. 12(A) is a conceptual diagram illustrating an example of an image output in the process of the Step S56. As illustrated in FIG. 12(A), an image 500 captured by the imaging unit 14 of the terminal 10ad and an image 510 based on the image data received by the transmitter-receiver 51 are displayed on the display 120ad. After restricting output of the sound data based on the restriction require information, a dialog 520 indicating a restriction of transmitting the sound data from the terminal 10ad is displayed by the display control unit 16. Accordingly, it is possible for a user of the terminal 10ad to confirm that the terminal 10ad itself is not the cause of lack of the sound data. Note that the terminal 10aa chooses several terminals (10ab, 10ad) serving as the destination terminal so that it is possible for more than three terminals to create the content data session “sed”.

### <Exiting>

Next, it will be illustrated that after the content data session “sed” has been created among the terminals (10aa, 10ab, 10ad), a process is executed when the terminal 10aa exits the content data session due to, for example, unplugging of a communication cable connecting the network I/F 111 of the terminal 10aa.

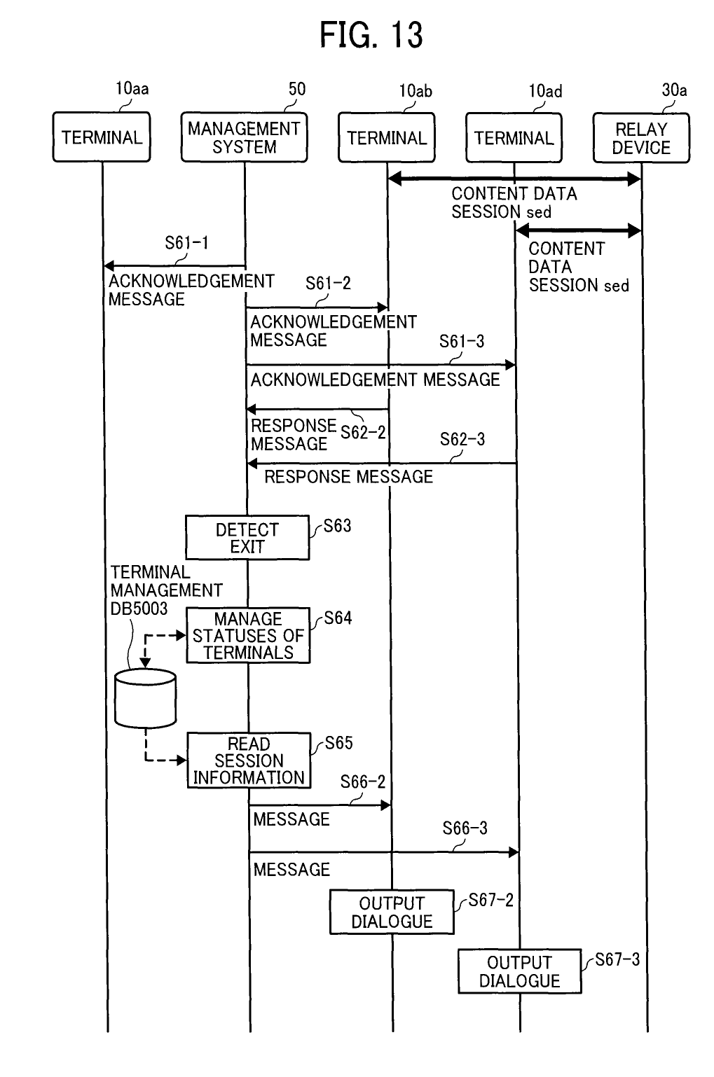

FIG. 13 is a sequence diagram illustrating a process when the terminal 10aa exits the content data session “sed”. The management system 50 transmits an acknowledgement message indicating acknowledgement of a status of the network connection to each terminal (10aa, 10ab, 10ad) connecting with the management system 50 at a given time (from Step S61-1 to Step S61-3). When the terminals (10ab, 10ad) receive the acknowledgement message, they each transmit a response message corresponding to the acknowledgement message to the management system 50 (from Step S62-2, Step S62-3). The transmitter-receiver 51 of the management system 50 transmits the acknowledgement message to the terminal 10aa. However when the transmitter-receiver 51 does not receive a response message indicating the terminal 10aa's continued participation in the content data session “sed” from the terminal 10aa after a predetermined time has passed, the management system 50 detects terminal 10aa's exit from the content data session “sed” (Step S63).

When the management system 50 detects terminal 10aa's exit, the terminal management unit 53 changes to OFF LINE the OPERATING STATUS field of the record indicating terminal ID (01aa) of the destination terminal 10aa in the terminal management table (See FIG. 6 (B)) (Step S64). Note that in the process of the Step S64, the terminal management unit 53 does not change the value in the SESSION ID, CONFERENCE MODE and OWNER INFORMATION field of the record indicating terminal ID (01aa) of the destination terminal 10aa. Accordingly, even when the terminal 10aa exits the content data session “sed”, the terminal 10aa maintains the authority for transmitting the sound data in this session.

Next, the terminal management unit 53 reads the session ID (se1) and the owner information “1” associated with the terminal ID (01aa) of the terminal 10aa that exited the content data session “sed” (Step S65). The terminal management unit 53, as a part of the process of the Step S65, searches the terminal management table by the session ID (se1), and retrieves the terminal IDs (01ab, 01ad) of the participant terminals.

Next, the transmitter-receiver 51 transmits a message indicating terminal 10aa's exit from the content data session “sed”, the message including the terminal ID (01aa) of the terminal 10aa and the “1” of the owner information of the terminal 10aa, to the terminals (10ab, 10ad) corresponding to the terminal IDs (01ab, 01ad) read by the Step S65 (Step S66-2, S66-3). When the terminals (10ab, 10ad) receive the message, as illustrated in FIG. 12(B), the display control unit 16 causes a dialog 530, indicating that the terminal which is able to transmit the sound data has exited the conference, to be displayed on the display 120. Accordingly, although the terminal participating in this session no longer outputs the sound data, due to the terminal 10, which has the authority of transmitting the sound data, exiting from the content data session “sed”, the output dialog 530 prevents a user from misunderstanding the speaker 115's failure.

### <Participation>

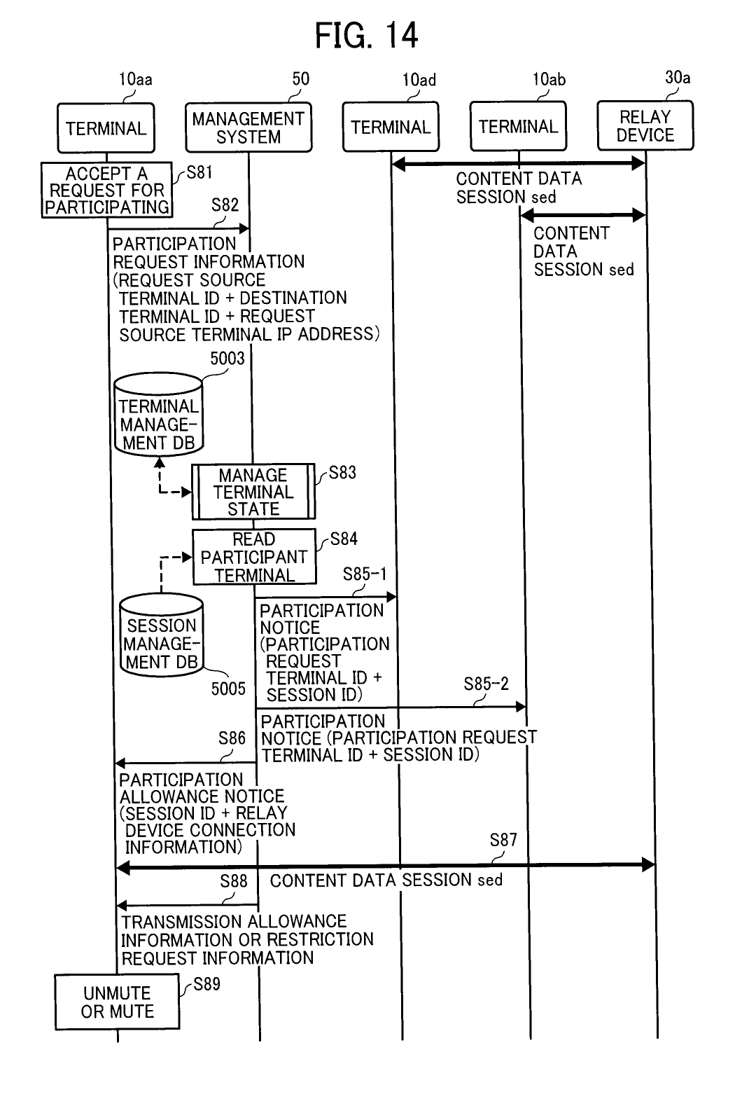

Next, a process for enabling, after the terminal 10aa exits the content data session “sed”, the terminal 10aa to participate again in the content data session “sed” will be described using FIG. 14. FIG. 14 is a sequence diagram illustrating a process of participation in the content data session “sed”. In the process illustrated FIG. 14, various type of information are transmitted/received in a management information session “sei”.

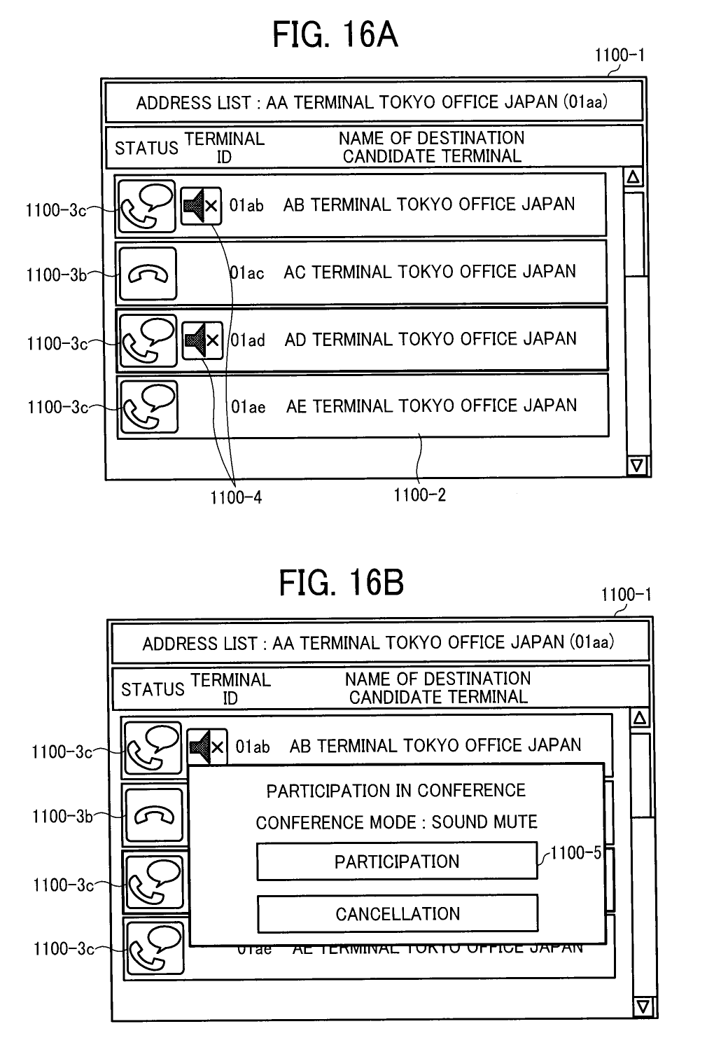

The terminal 10ab logs in to the management system 50 in the same way as the process from the Step S21 to the Step S34. The display 120aa of the terminal 10aa displays the address list as shown by FIG. 16(A). FIG. 16(A) is a conceptual diagram illustrating an address list according to an embodiment. Note that at the time that the address list is displayed on the display 120aa of the terminal 10aa, the terminal (10ab, 10ad) in the sound mute mode is participating in the content data session “sed”. Accordingly, the display control unit 16 of the terminal 10aa displays an icon 1100-4 identifying a status of the terminals (10ab, 10ad) that are restricted for transmitting the sound data based on the status information (the value of “CONFERENCE MODE” is “sound mute” and the value of “OWNER INFORMATION” is “0”) of the terminals (10ab, 10ad) transmitted from the management system 50 (See Step S32).

Next, when the user of the terminal 10aa selects the operation keys 108 to select the terminal 10ad from the destination candidate terminals (see FIG. 16(A)) displayed on the display 120aa, the operation input acceptor 12 accepts a request for participating in the content data session “sed” participated by the terminal 10ad (Step S81). Next the display control unit 16 causes a key 1100-5, for participating in the conference illustrated in a FIG. 16(B), to be displayed on the display 120aa. In response to a user selecting the key 1100-5, the data transmitter/receiver 11 of the terminal 10aa transmits to the management system 50 the IP address of the terminal 10aa, the terminal ID (01aa) of the terminal 10aa serving as the participation request source terminal, and participation request information that includes the terminal ID (01ad) of the terminal 10ad serving as the destination terminal. The participation request information indicates a request for participation in the content data session “sed” (Step S82).

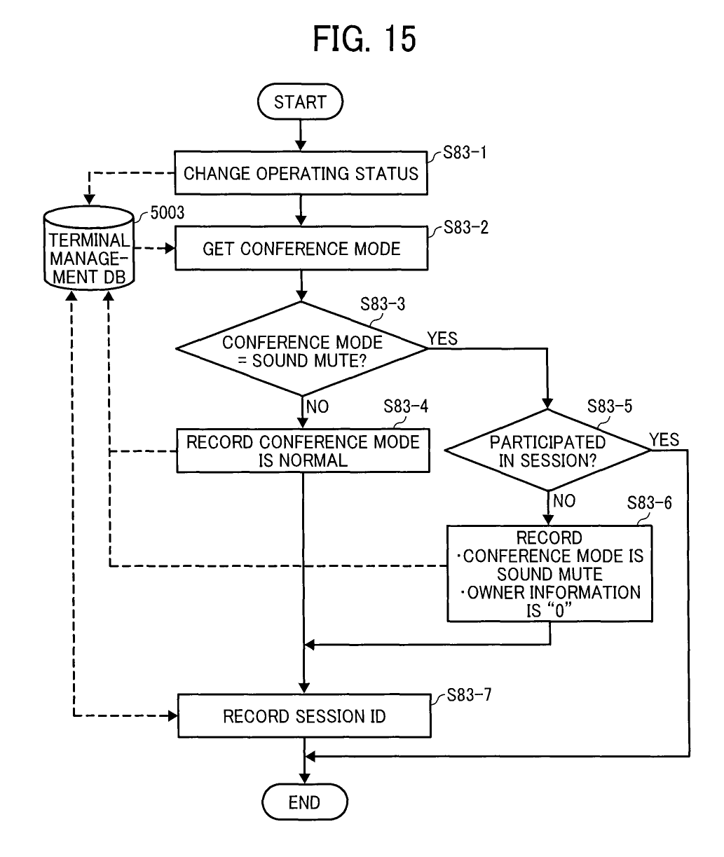

When the transmitter-receiver unit 51 receives this participation request information, the terminal management unit 53 updates the terminal management table (See FIG. 6(B)) (Step S83). The process of Step S83 will be described using FIG. 15. FIG. 15 is a flowchart illustrating a process of updating the status of the terminal 10.

The terminal management unit 53 changes to ON LINE (COMMUNICATING) the OPERATING STATUS field of the record indicating terminal ID (01aa) of the destination terminal 10aa serving as the participation request source terminal in the terminal management table (See FIG. 6(B)) (Step S83-1). The terminal management unit 53 retrieves a value in the CONFERENCE MODE field for the record indicating terminal ID (01ad) of the destination terminal 10ad (Step S83-2). The terminal management unit 53 determines whether the value of the CONFERENCE MODE for the determination terminal retrieved in the process of Step S83-2 is the SOUND MUTE or not. When the value of the CONFERENCE MODE is not the SOUND MUTE, the terminal management unit 53 records “NORMAL” in the CONFERENCE MODE field of the record corresponding to the terminal ID (01aa) of the terminal 10aa serving as the participation request source terminal in the terminal management table (Step S83-4).

When the value of the CONFERENCE MODE is the “SOUND MUTE”, the terminal management unit 53 determines whether or not the terminal 10aa, serving as the participant request terminal, has participated in the content data session as the destination terminal (Step 83-5). In the terminal management table, when the session ID associated with the terminal ID (01aa) of the terminal 10aa serving as the participant request source terminal matches the session ID associated with the terminal ID (01ad) of the terminal 10ad serving as the destination terminal, the terminal management unit 53 determines that the terminal 10aa serving as the participant request source terminal had participated in the content data session “sed” with the destination terminal. In the terminal management table, when there is no value of the SESSION ID field of the record corresponding to the terminal ID (01aa) of the terminal 10aa serving as the participation request source terminal, or when the session ID associated with the terminal ID (01aa) of the terminal 10aa serving as the participant request source terminal does not match the session ID associated with the terminal ID (01ad) of the terminal 10ad serving as the destination terminal, the terminal management unit 53 determines that the terminal 10aa serving as the participant request source terminal has not participated in the content data session “sed” with the destination terminal.

When the terminal management unit 53 determines that the terminal 10aa serving as the participant request source terminal has not participated in the content data session “sed” with the destination terminal, the terminal management unit 53 records, “SOUND MUTE” in the CONFERENCE MODE field and “0” in the OWNER INFORMATION field of the record corresponding to the terminal ID (01aa) of the terminal 10aa serving as the participation request source terminal in the terminal management table (Step S83-4) (Step S83-6).

When the terminal management unit 53 determines that a value of the CONFERENCE MODE field of the destination terminal is not the “SOUND MUTE” (Step S83-3 No), or that the terminal 10aa serving as the participation request source terminal has not participated in the content data session “sed” with the destination terminal (Step S83-5 No), the terminal management unit 53 retrieves a value of the session ID associated with the terminal ID (01ad) of the terminal 10ad serving as the destination terminal (Step S83-7). Further, the terminal management unit 53 records the retrieved value of the session ID as the session ID associated with the terminal ID (01aa) of the terminal 10aa serving as the participation request source terminal.

Note that when the terminal 10aa serving as the participation request source terminal has participated in the content data session “sed” with the destination terminal, the terminal management unit 53 does not change values of the “SESSION ID”, “CONFERENCE MODE” and “OWNER INFORMATION” fields of the record corresponding to the terminal ID (01aa) of the terminal 10aa because this information has already been recorded in the terminal management DB. Accordingly, the terminal 10aa can again participate in the content data session “sed” in the same situation that the terminal 10aa had previously participated in the content data.

Next, the terminal management unit 53 reads, in reference to the terminal management table (See FIG. 6(B)), the session ID (se1) of the session in which the terminal 10ad serving as the destination terminal is participating. The terminal management unit 53 further reads the terminal ID of the terminal 10ab participating in the session identified with session ID (se1) (Step S84).

Next, the transmitter-receiver unit 51 of the management system 50 transmits a participation notice including the terminal ID (01aa) of the terminal 10aa serving as the terminal requesting indicating participation in the content data session “sed” and the session ID (se1) to each terminal (10ad, 10ab) that has already participated in the content data session (Step S85-1, S85-2). Accordingly, the terminals (10ad, 10ab) can be informed of the terminal 10aa participation in the content data session.

Furthermore, the transmitter-receiver unit 51 of the management system 50 transmits the session ID (se1) of the content data session “sed” and a participation permission notice, including the relay device connection information used in connection with the relay device 30a, to the terminal 10aa serving as the participation request source terminal (Step S86).

The terminal 10aa connects with the relay device 30a using the relay device connection information. Accordingly, a content data session “sed” is established among the terminal 10aa, the terminal 10ad, and the terminal 10ab (Step S88).

The transmitter-receiver unit 51 transmits transmission permission information indicating permission for transmitting the sound data to the terminal 10aa when a value of the

“OWNER INFORMATION” field of the record corresponding to the terminal ID (01aa) of the terminal 10aa serving as the participation request source terminal is “1” (Step S88). The transmitter-receiver unit 51 transmits restriction request information indicating a restriction on transmitting the sound data to the terminal 10aa when a value of the “OWNER INFORMATION” field of the record corresponding to the terminal ID (01aa) of the terminal 10aa, serving as the participation request source terminal, is “0” (Step S88).

When the transmitter-receiver unit 11 of the terminal 10aa receives the transmission permission information, the imaging unit 14 starts outputting the image data from the camera 112 and the sound input unit 15a starts outputting the sound data by unmuting the microphone 114 (Step S89). The transmitter-receiver unit 11 of the terminal 10aa transmits the output image data and the sound data to the relay device 30a within the content data session “sed”. The relay device 30a relays the received image data and sound data to the terminals (10ad, 10ab) participating in this content data session thereby relaying the content data. Accordingly, the terminals (10ad, 10ab) can receive the image data and the sound data transmitted from the terminal 10aa.

When the transmitter-receiver unit 11 of the terminal 10ab receives the restriction request information, the imaging unit 14 starts outputting the image data and the sound output unit 15b restricts outputting of the sound data (Step S89). Accordingly, the terminal 10aa is not permitted to transmit the sound data within the content data session “sed”.

### Second Embodiment

Next, the points of a second embodiment of the present embodiments that are different from the first embodiment will be described. The second embodiment will describe that the transmitter-receiver unit 11 transmits the transmission permission information to the terminal participating in the content data session “sed” when the terminal specified by the “1” in the “OWNER INFORMATION” field exits the content data session “sed”. When the terminal 10 participating in the content data session “sed” receives the transmission permission information, the sound input unit 15a starts creating the sound data. Accordingly, the restriction on transmitting the sound data from this terminal is thereby cancelled.

The terminal management DB 5003 of the second embodiment manages and stores sub owner information specifying the terminal 10 for which the restriction on transmitting the sound data will be cancelled in response to the exiting from the content data session of the terminal specified by “1” in the “OWNER INFORMATION” field. Accordingly, the transmitter-receiver unit 51 can transmit the transmission permission information to the terminal 10 specified by the sub owner information.

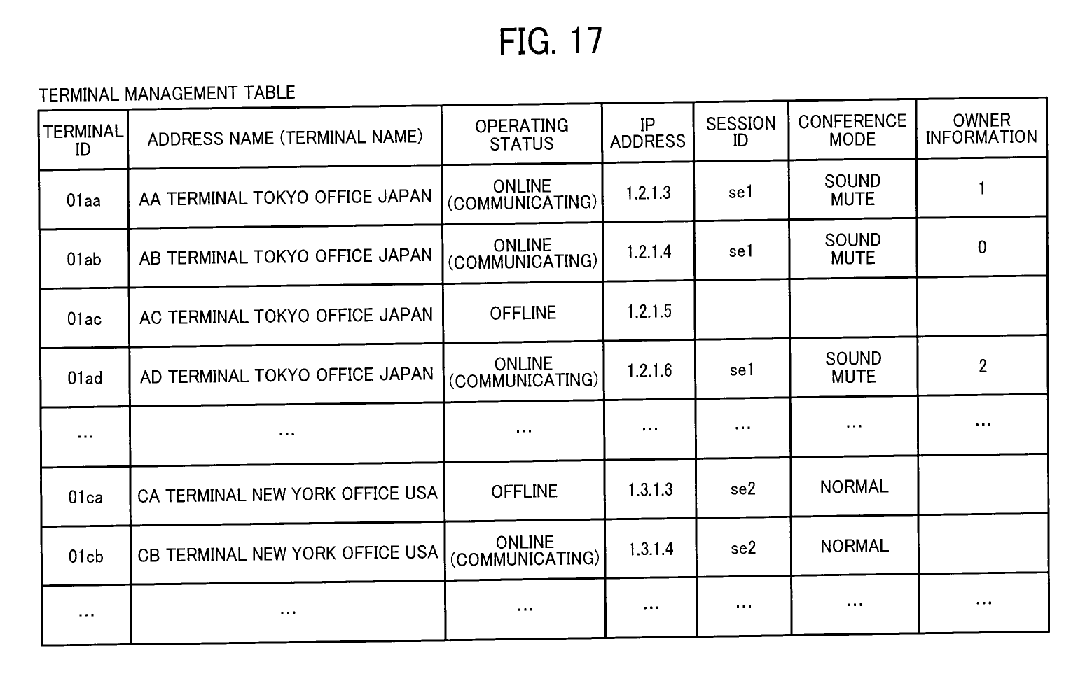

FIG. 17 is a conceptual diagram illustrating a terminal management table of the second embodiment. The terminal management table illustrated in FIG. 17 manages a value “2” indicating the sub owner of the conference in the OWNER INFORMATION field. The terminal 10 specified as the sub owner of the conference has the authority to transmit the image data to any terminal 10 participating in the conference and restricts the authority to transmit the sound data from any other terminal 10 participating in the conference. The restriction on transmitting the sound data is cancelled during the period that the terminal 10 specified as the owner is not participating in the conference.

Note that the transmitter-receiver unit 11 of the terminal 10 receives the transmission permission information from the management system 50. When the transmitter-receiver unit 11 receives the transmission permission information, the sound input unit 15a starts creating the sound data based on the input sound. Accordingly, the restriction on transmitting the sound data from the terminal 10 can be canceled.

In the second embodiment, in the process of Step S53-2 (See FIG. 10), the terminal management unit 53 changes to “2” the OWNER INFORMATION field of the record indicating terminal ID (01ad) of the terminal 10ad serving as the destination terminal in the management table (See FIG. 6(B)). That is, when the terminal 10 serving as the request source terminal requests the initiation of communication in the sound mute mode, the destination terminal is the terminal specified as the sub owner.

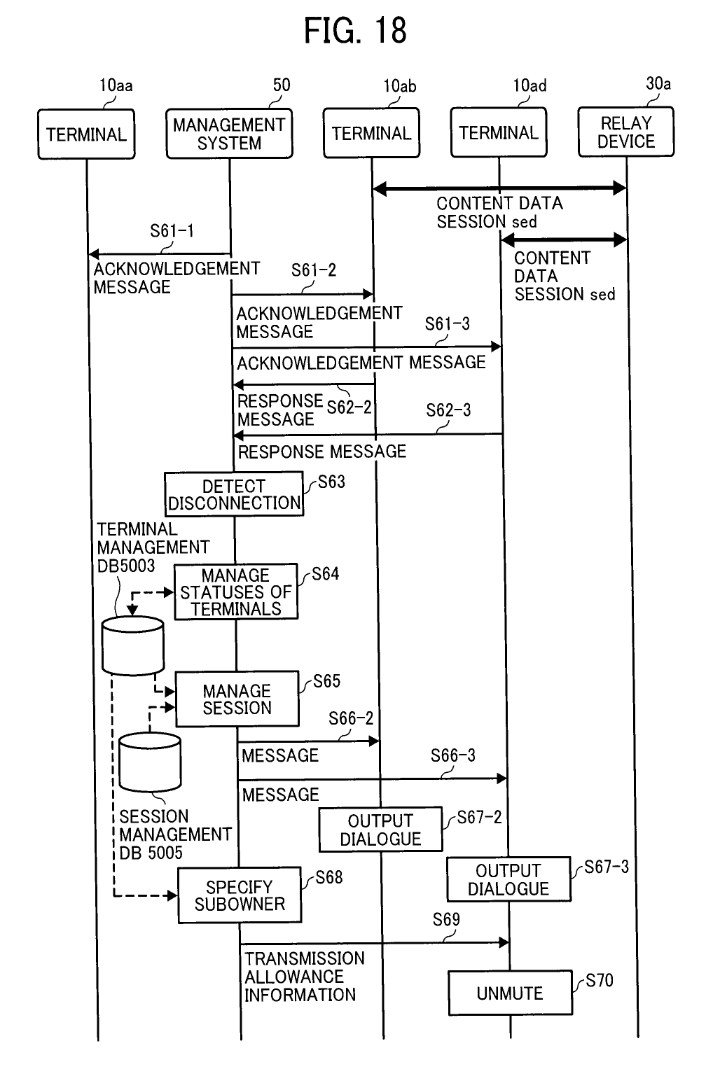

FIG. 18 is a sequence diagram illustrating a process when the terminal 10aa exits the content data session “sed”. In the second embodiment, the terminal management unit 53 searches the terminal management table (See FIG. 17) by the terminal ID (01aa) of the terminal 10aa and retrieves the session ID (se1) associated with the terminal ID (01aa) at the given time after detecting terminal 10aa's exit from the content data session (Step S63). The terminal management unit 53 specifies the terminal 10ad as having the owner information “2” by referencing the OWNER INFORMATION field of each record having the session ID (se1) (Step S68).

Next, the transmitter-receiver unit 51 of the management system 50 transmits the transmission permission information indicating permission to transmit the image data and the sound data to the terminal 10ad which is determined to be the sub owner (Step S69).

When the transmitter-receiver unit 11 of the terminal 10ad receives the output permission information, an imaging unit 14 starts outputting the image data from the camera 112 and the sound input unit 15a starts outputting the sound data by unmuting the microphone 114 (Step S70). The transmitter-receiver unit 11 of the terminal 10ad transmits the output image data and sound data to the relay device 30a within the content data session “sed”. The relay device 30a transmits the received image data and sound data to the terminal 10ab which is participating in the content data session “sed”. Accordingly, the terminal 10ab receives the image data and sound data sent from the terminal 10ad.

In this embodiment, the address list frame 1100-1 including the destination names 1100-2, icons 1100-3a and the like is displayed as illustrated in FIG. 9A-B; however, the destination names 1100-2, icons 1100-3a and the like may be displayed without the address list frame 1100-1.

Further, according to the embodiment, the management system 50 and the program providing system 90 may be integrated in a single computer, or various functions and units of the management system 50 and the program providing system 90 may be separately arranged in two or more computers. Moreover, if the program providing system 90 is formed in a single computer, programs transmitted via the program providing system 90 may be grouped into two or modules or may not be grouped. Further, if the program providing system 90 is formed of two or more computers, the programs grouped into modules may be transmitted from the separate computers.

Moreover, according to the embodiment, recording media storing a terminal program, a relay device program and a communication management program, and the program providing system 90 including the HD 204 storing such programs may be distributed to users domestically and abroad as a program product.

Moreover, according to the embodiment, the IP addresses of the terminals are managed by the terminal management table as illustrated in FIGS. 6(B). However, alternatively, respective fully qualified domain names (FQDNs) of the terminals 10 may be managed instead of the respective IP addresses. In this case, a known domain name system (DNS) server may acquire the IP address corresponding to the FQDN.

In this embodiment, the terms “videoconference” and “teleconference” may be interchangeably used.

Further, according to the above embodiment, the video conference system is described as an example of the communication system 1; however, the communication system 1 may not be limited to the video conference system. The communication system 1 may be a telephone system such as an Internet protocol (IP) phone or an Internet phone. Further, the communication system 1 may be a car navigation system. In this case, one of the terminals 10 may be a car navigation device mounted on a vehicle and the other terminal 10 may be a management terminal or a management server configured to manage the car navigation, or another car navigation device mounted on another vehicle. Further, the communication system 1 may be a sound conferencing system or a personal computer (PC) screen shared system.

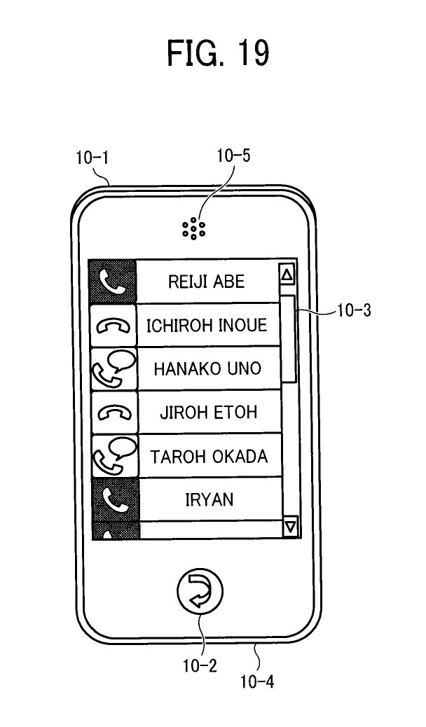

In addition, the communication system 1 may be a mobile phone communication system. In this case, the terminal 10 may be a mobile phone terminal. FIG. 19 illustrates an example of an address list displayed on the mobile phone terminal. Specifically, the mobile phone terminal as the terminal 10 includes a main body 10-1, a menu screen display button 10-2 arranged on the main body 10-1, a display unit 10-3 arranged on the main body 10-1, a microphone provided in a lower part of the main body 10-1 and a speaker provided in a surface of the main body 10-1. Among these, the “menu screen display button” 10-2 is utilized for displaying a menu screen on which icons of various applications are displayed. The display unit 10-3 is formed of a touch panel on which the user touches with a finger or hand to select a desired address name to communicate with a person of the desired address name.

Further, according to the above embodiment, the image data and the sound data are described as an example of the content data; however, the content data may not be limited to the image data or the sound data. The content data may be touch data (tactile data). In this case, a tactile sense obtained by the user who has touched one terminal may be transmitted to the other terminal. Further, the content data may be smell (olfactory sense) data. In this case, the smell (odor) obtained by one terminal may be transmitted to the other terminal. Further, the content data may be at least one of the image data, the sound data, the touch data and the smell data.

Moreover, according to the above embodiment, the video conference system implemented by the communication system 1 is described; however, the communication system 1 may not be limited to the video conference system. The communication system 1 may be utilized for a preliminary meeting, a general conversation between family members or friends, or one-way presentation of information.

As described above, in the transmission system according to the embodiment, a transmission management system manages a communication status of a first transmission terminal that communicates with a second transmission terminal. When the transmission management system receives alteration information for altering the communication status of the first transmission terminal from the first transmission terminal, the transmission management system alters the communication status of the first transmission terminal based on the received alteration information and the communication status of the first transmission terminal managed by the transmission management system. Accordingly, since the transmission management system detects the communication status of the first transmission terminal, the transmission management system may effectively control connection between the first and second transmission terminal.

The advantages illustrated above are merely examples of the most preferred ones provided by the embodiments, and therefore are not limited to those described in the embodiments.

Embodiments of the present invention have been described heretofore for the purpose of illustration. The present invention is not limited to these embodiments, but various variations and alterations may be made without departing from the scope of the present invention. The present invention should not be interpreted as being limited to the embodiments that are described in the specification and illustrated in the drawings.

The present application is based on Japanese Priority Application No. 2010-169434 filed on Jul. 28, 2010 and Japanese Priority Application No. 2011-107320 filed on May 12, 2011, with the Japanese Patent Office, the entire contents of which are hereby incorporated by reference.

The relay devices 30, the management system 50, and the program providing system 90 in the above-described embodiments may be configured by a single computer or a plurality of computers to which divided portions (functions) are arbitrarily allocated.

In addition, in the case where the program providing system 90 is configured by a single computer, a program transmitted by the program providing system 90 may be separately transmitted in units of a plurality of modules, or may be transmitted in its entirety.

Further, in the case where the program providing system 90 is configured by a plurality of computers, a program may be divided into a plurality of modules, and the modules may be individually transmitted from the respective computers.

In addition, a recording medium such as a compact disc read-only memory (CD-ROM) storing a terminal control program, a relay device program, or a communication management program in the above-described embodiments, the HD 204 storing these programs, and the program providing system 90 including the HD 204 are each used in the case where the terminal control program, relay device program, or communication management program is provided as a program product to users within a certain country or outside that country.

Further, although management is performed while paying attention to the resolution of an image of image data relayed by the relay device 30, which serves as an example of the quality of the image of the image data, the embodiments are not limited to this case, and management may be performed while paying attention to other examples of the quality, such as the depth of the quality of image data, the sampling frequency of sound of sound data, or the bit length of sound of sound data. In addition, sound data may be transmitted/received separately in items of data of three types of resolutions (high resolution, intermediate resolution, and low resolution).

Although the IP address of each terminal 10 is managed in FIGS. 8A-B, the embodiments are not limited to this case, and any information for identifying each terminal 10 in the communication network 2, such as the fully qualified domain name (FQDN) of each terminal 10, may be managed. In this case, an IP address corresponding to an FQDN is obtained by a Domain Name System (DNS) server.

In addition, although the case of a videoconference system has been described as an example of the communication system 1 in the above-described embodiments, the embodiments are not limited to this case, and the communication system 1 may be a phone system such as an IP phone system or an Internet phone system.

In addition, the communication system 1 may be a car navigation system. In this case, for example, one of two terminals 10 corresponds to a car navigation apparatus mounted on a car, and the other terminal 10 corresponds to a management terminal or a management server of a management center that manages car navigation, or a car navigation apparatus mounted on another car. In addition, the terminals 10 may be configured by cellular phones in the communication system 1.

In addition, although image data and sound data are described as examples of content data in the above-described embodiments, the content data is not limited to these items of data, and the content data may be touch data. In this case, a feeling obtained by a user's contact at one terminal side is transmitted to the other terminal side.

Further, the content data may be smell data. In this case, a smell at one terminal side is transmitted to the other terminal side. In addition, the content data may be at least one of image data, sound data, touch data, and smell data.

In addition, although the case in which a videoconference is held by the communication system 1 has been described in the above-described embodiments, the embodiments are not limited to this case. The communication system 1 may be used in meetings, general conversation between family members or friends, or one-way presentation of information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In one example, the present invention may reside in A method of managing information regarding one or more counterpart communication terminals for a communication terminal that is participating in a session with at least one counterpart communication terminal, the method including: receiving information indicating that the counterpart communication terminal is not registered as a candidate counterpart terminal for the communication terminal, from a counterpart terminal management system; displaying a user interface component that allows a user to send a request for adding the counterpart communication terminal as a candidate counterpart terminal for the communication terminal;

and transmitting the request for adding the counterpart communication terminal as a candidate counterpart terminal for the communication terminal, to the counterpart terminal management system, in response to selection of the user interface component by the user.

In one example, the method further includes: receiving information indicating acceptance of the request for adding from the counterpart terminal management system; and displaying a user interface component indicating that the request for adding is accepted, in alternative to the user interface component allowing the user to send the request for adding.

In one example, the method further includes: receiving information indicating that addition of the communication terminal as a candidate counterpart terminal for the communication terminal is completed, from the counterpart terminal management system, and displaying a user interface component indicating that addition of the communication terminal is completed, in alternative to the user interface component indicating that the request for adding is accepted.

In one example, the displaying displays the user interface component that allows a user to send a request for adding, with identification information for identifying one or more counterpart communication terminals that are participating in the session.

1. A server for managing a communication system, comprising:
a terminal management database storing terminal information identifying each terminal and indicating an ownership status for each terminal;
a session management database storing information regarding a session; and
circuitry configured to
in response to an initiation request from an initiating terminal, generate a session ID and allocate a relay device,
update the session management database based on the generated session ID and allocated relay device,
instruct transmission of information identifying the generated session ID and the allocated relay device to the initiating terminal and one or more destination terminals identified by the requesting terminal,
establish a content data session between the requesting terminal and the one or more destination terminals,
designate an owner terminal and one or more participating terminals for the content data session from the requesting terminal and the one or more destination terminals based on information in the terminal management database, and
instruct transmission of sound permission instructions to the owner terminal and sound restriction instructions to the one or more participating terminals, the sound permission instructions unmuting the owner terminal and the sound restriction instructions muting the participating terminals.

2. The server according to claim 1, wherein the initiation request from the initiating terminal includes information identifying a conference mode, and
the conference mode is selected from one of a sound mute mode and a mutual communication mode.

3. The server according to claim 2, wherein the circuitry designates the owner terminal and one or more participating terminals for the content data session and instructs transmission of the sound permission instructions to the owner terminal and the sound restriction instructions to the one or more participating terminals only when the initiation request includes the information identifying the conference mode as the sound mute mode.

4. The server according to claim 3, wherein when the initiation request includes the information identifying the conference mode as the mutual communication mode, each of the requesting terminal and one or more destination terminals receive sound permission instructions instructing unmuting of the respective terminal.

5. The server according to claim 3, wherein the circuitry is further configured to receive a confirmation or a rejection of the content data session from each of the one or more destination terminals, the one or more destination terminals initiating an obtaining of the confirmation or rejection of the content data session in response to the receipt of the information identifying the generated session ID and the allocated relay device.

6. The server according to claim 1, wherein in response to the owner terminal exiting the content data session due to lack of connectivity, the circuitry is further configured to instruct transmission of a notification to the one or more participating terminals indicating that the owner terminal has exited the content data session.

7. The server according to claim 1, wherein when the owner terminal reconnects to the server after exiting the content data session due to lack of connectivity, the owner terminal is rejoined to the content data session and the circuitry is further configured to again instruct transmission of the sound permission instructions to the owner terminal.

8. The server according to claim 1, wherein in response to the owner terminal exiting the content data session due to lack of connectivity, the circuitry is further configured to re-designate one of the one or more participating terminals as a new owner terminal and instruct transmission of the sound permission instructions to the new owner terminal.

9. A method for managing a communication system including a server and a plurality of terminals, comprising:
in response to an initiation request from an initiating terminal of the plurality of terminals, generating a session ID and allocate a relay device;
updating a session management database storing information regarding a session based on the generated session ID and allocated relay device;
instructing transmission of information identifying the generated session ID and the allocated relay device to the initiating terminal and one or more destination terminals identified by the requesting terminal;
establishing a content data session between the requesting terminal and the one or more destination terminals;
designating an owner terminal and one or more participating terminals for the content data session from the requesting terminal and the one or more destination terminals based on information in a terminal management database storing terminal information identifying each terminal and indicating an ownership status for each terminal; and
instructing transmission of sound permission instructions to the owner terminal and sound restriction instructions to the one or more participating terminals, the sound permission instructions unmuting the owner terminal and the sound restriction instructions muting the participating terminals.

10. The method according to claim 9, wherein the initiation request from the initiating terminal includes information identifying a conference mode, and
the conference mode is selected from one of a sound mute mode and a mutual communication mode.

11. The method according to claim 10, further comprising:
identifying the owner terminal and one or more participating terminals for the content data session; and
instructing transmission of the sound permission instructions to the owner terminal and the sound restriction instructions to the one or more participating terminals only when the initiation request includes the information identifying the conference mode as the sound mute mode.

12. The method according to claim 11, further comprising:
when the initiation request includes the information identifying the conference mode as the mutual communication mode, receiving, at each of the requesting terminal and one or more destination terminals, sound permission instructions instructing unmuting of the respective terminal.

13. The method according to claim 11, further comprising:
receiving a confirmation or a rejection of the content data session from each of the one or more destination terminals, the one or more destination terminals initiating an obtaining of the confirmation or rejection of the content data session in response to the receipt of the information identifying the generated session ID and the allocated relay device.

14. The method according to claim 9, further comprising:
in response to the owner terminal exiting the content data session due to lack of connectivity, instructing transmission of a notification to the one or more participating terminals indicating that the owner terminal has exited the content data session.

15. The method according to claim 9, further comprising:
when the owner terminal reconnects to the server after exiting the content data session due to lack of connectivity, rejoining the owner terminal to the content data session and again instructing transmission of the sound permission instructions to the owner terminal.

16. The method according to claim 9, further comprising:
in response to the owner terminal exiting the content data session due to lack of connectivity, re-designating one of the one or more participating terminals as a new owner terminal and instructing transmission of the sound permission instructions to the new owner terminal.

17. A terminal for initiating a content data session with one or more destination terminals, comprising:
video capturing circuitry configured to capture still and dynamic pictures;
audio capturing circuitry configured to capture audio;
circuitry configured to
receive information identifying a generated session ID and an allocated relay device,
receive sound permission instructions when the terminal is designated by the server as an owner terminal and receive sound restriction instructions when the terminal is designated by a server as a participating terminal, the sound permission instructions unmuting the owner terminal and the sound restriction instructions muting the participating terminal, and
transmit both audio and video respectively captured by the video capturing circuitry and the audio capturing circuitry when sound permission instructions are received and the terminal is designated as the owner terminal.

18. The terminal according to claim 17, wherein the circuitry is further configured to instruct transmission of an initiation request for initiating the content data session with one or more destination terminals to the server.

19. The terminal according to claim 17, wherein when the terminal is designed as the owner terminal, the circuitry is further configured to:
instruct display of an option screen permitting selection from one or more destination terminals, and
in response to receiving selection of one of the one or more destination terminals, instruct display of a second option screen permitting selection of one of a sound mute mode and a mutual communication mode for the content data session.

20. The terminal according to claim 17, wherein when the terminal is designed as the participating terminal, the circuitry is further configured to:
instruct display of an option screen permitting confirmation or rejection of the content data session.
